(19) United States
(12) Patent Application Publication
(10) Pub. No.: US 2023/0369644 A1
(43) Pub. Date: Nov. 16, 2023

(54) High Performance Solid-State Electrolyte and Battery Based on Polysiloxane Si-tripodand Polymers and Manufacturing Method Thereof

(71) Applicant: Nuvvon, Inc., Bordentown, NJ (US)

(72) Inventor: Manveer S. Sidhu, Levittown, PA (US)

(21) Appl. No.: 18/316,790

(22) Filed: May 12, 2023

Related U.S. Application Data
(60) Provisional application No. 63/341,417, filed on May 12, 2022.

(51) Int. Cl. H01M 10/0565; H01M 4/58; H01M 4/505; H01M 4/62; H01M 4/04; H01M 10/058; H01M 4/525

(52) U.S. Cl. CPC H01M 10/0565; H01M 4/5825; H01M 4/505; H01M 4/623; H01M 4/625; H01M 4/0404; H01M 4/0435; H01M 10/058; H01M 4/525; H01M 2300/0082; H01M 2004/028

(57) ABSTRACT

A polymer electrolyte, in a first embodiment, a salt in polymer electrolyte (SiPE), including a polysiloxane Si-tripodand polymer, a lithium bis(trifluoromethanesulfonyl)imide, and a lithium tetrafluoroborate. In a second embodiment, a polymer in salt electrolyte (PiSE), including a polysiloxane Si-tripodand polymer, a polyvinylidene difluoride, and a lithium bis(trifluoromethanesulfonyl)imide. The polymer electrolyte can be formed into a free-standing membrane. The various embodiments of the polymer electrolyte can be formed as a composite cathode and also as a polymer electrolyte separator. A rechargeable battery cell, including the composite cathode as a positive electrode, a negative electrode, and the polymer electrolyte separator separating the positive electrode and the negative electrode. The positive electrode, the negative electrode, and the polymer electrolyte separator are completely solid.

### CROSS-REFERENCE TO RELATED APPLICATION

This application claims priority under 35 U.S.C. § 119(e) to U.S. Provisional Patent Application No. 63/341,417 filed on May 12, 2022, which is incorporated herein by reference in its entirety.

### BACKGROUND

The present disclosure relates to the field of electrochemical cells, including electrolyte materials, electrodes, and other components used in electrochemical cells.

Solid state lithium-ion batteries (“solid state batteries”) use a solid electrolyte as opposed to a liquid electrolyte. Solid-state batteries may also use solid electrolyte in combination with liquid electrolytes or other non-solid components. Solid-state batteries generally have higher energy density than comparable lithium-ion batteries built with a liquid electrolyte. Solid-state batteries are also intrinsically safer than lithium-ion batteries that utilize liquid electrolytes because solid electrolytes are not as flammable as liquid electrolytes. Polymers are highly suited to fabricating solid electrolytes due to their low flammability, processability, flexibility, structural stability, thermal stability, and wide electrochemical stability window. The present disclosure relates to polymer electrolytes and lithium-ion rechargeable battery cells with polymer electrolyte based components.

Conventional polymer electrolytes utilize a polymer known as polyethylene oxide (PEO) as the polymer host. PEO can be a polymer host for solid polymer electrolytes as it is economical, can be readily made into films, and has strong solvating properties for a variety of lithiated salts. However, due to the semicrystalline structure of pristine PEO, PEO-based polymer electrolytes exhibit low ionic conductivity at room temperature (10⁻⁸ to 10⁻⁶ S/cm), which is not practical for lithium-ion batteries.

To achieve the necessary level of ionic conductivity, the operating temperature of PEO-based polymer electrolytes must be raised above PEO's melting point (>65° C.) so the semicrystalline regions become amorphous. This operating temperature requirement restricts the practical application of the cell. The higher operating temperature also creates other problems since higher temperatures lead to softer polymeric membranes, which can increase the likelihood of short-circuits. Efforts to reduce the semicrystalline regions of PEO at room temperature through the addition of plasticizers, solvents, and other additives tend to result in films with poor mechanical strength and/or safety and are not suitable for large scale manufacturing. Polymer electrolytes formulated using other polymers such as polyacrylonitrile (PAN) and polyvinyl pyrrolidone (PVP) also suffer from poor ionic conductivity.

The subject matter claimed herein is not limited to embodiments that solve any disadvantages or that operate only in environments such as those described above. Rather, this background is only provided to illustrate one example technology where some embodiments described herein may be practiced.

### SUMMARY

In one aspect of the disclosure, a polymer electrolyte is provided, the polymer electrolyte including a polysiloxane Si-tripodand polymer (“PEST”), a lithium bis(trifluoromethanesulfonyl)imide (“LiTFSI”) and a lithium tetrafluoroborate (“LiBF₄”). According to various embodiments, the polymer electrolyte may be made up of 70 wt % to 90 wt % of the PEST. According to other embodiments, the polymer electrolyte may also be made up of 8.0 wt % to 29.75 wt % of the LiTFSI. Yet in other embodiments, the polymer electrolyte is made up of 0.25 wt % to 2.0 wt % of the LiBF₄. The polymer electrolyte has an ionic conductivity of 1×10⁻⁵ S/cm or greater at a temperature greater than or equal to 25° C. The PEST, the LiTFSI, and the LiBF₄ can be formed into a free-standing membrane.

In another aspect of the disclosure, a polymer electrolyte is provided, the polymer electrolyte including a polysiloxane Si-tripodand polymer (“PEST”), a polyvinylidene difluoride (“PVDF”), and a lithium bis(trifluoromethanesulfonyl)imide (“LiTFSI”). In some embodiments, the PVDF is a PVDF(534K). Yet in other embodiments, the PVDF is a PVDF(700K). Yet in another embodiment, the PVDF is a PVDF(HSV900). In the embodiment where the PVDF is a PVDF(534K), when the ratio of PVDF534K to LiTFSI is 50:50, the polymer electrolyte may have a PEST concentration of 5 wt % to 30 wt %; when the ratio is 40:60, the polymer electrolyte may have a PEST concentration of 5 wt % to 20 wt %; and when the ratio is 35:65, the polymer electrolyte may have a PEST concentration of 5 wt % to 10 wt %. In the embodiment where the PVDF is a PVDF(700K), when the ratio of PVDF(700K) to LiTFSI is 50:50, the polymer electrolyte may have a PEST concentration of 5 wt % to 30 wt %; when the ratio is 40:60, the polymer electrolyte may have a PEST concentration of 5 wt % to 30 wt %; when the ratio is 35:65, the polymer electrolyte may have a PEST concentration of 5 wt % to 20 wt %. In the embodiment where the PVDF is a PVDF(HSV900), when the ratio of PVDF(HSV900) to LiTFSI is 50:50, the polymer electrolyte may have a PEST concentration of 5 wt % to 30 wt %; when the ratio is 40:60, the polymer electrolyte may have a PEST concentration of 5 wt % to 25 wt %; when the ratio is 35:65, the polymer electrolyte may have a PEST concentration of 5 wt % to 20 wt %. The polymer electrolyte has an ionic conductivity of 1×10⁻⁵ S/cm or greater at a temperature greater than or equal to 25° C. The PEST, the PVDF, and the LiTFSI can be formed into a free-standing membrane.

Another aspect of the disclosure relates to a method of manufacturing a polymer electrolyte according to one embodiment of the present disclosure. A PEST is dissolved in a first organic solvent. A LiTFSI is dissolved in a second organic solvent. A LiBF₄ is also dissolved in the second organic solvent. The second organic solvent containing the LiTFSI and the LiBF₄ is added to the first organic solvent containing the PEST to obtain a mixture that is heated and mixed until it is homogeneous.

Yet another aspect of the disclosure relates to a method of manufacturing a polymer electrolyte according to another embodiment of the present disclosure. A PEST is dissolved in a first organic solvent. A LiTFSI is dissolved in a second organic solvent. A PVDF is added to the second organic solvent containing the LiTFSI. The second organic solvent containing the PVDF and the LiTFSI is then added to the first organic solvent containing the PEST to obtain a mixture that is heated and mixed until it is homogeneous.

Another aspect of the disclosure provides for a composite cathode including the various embodiments of the polymer electrolyte as described above mixed with a cathode active material, a carbon black, and a polyvinylidene difluoride binder, and formed as a cathode film on a current collector. In this aspect of the disclosure, the polymer electrolyte functions as a catholyte in the composite cathode. In one embodiment, the cathode active material can be a lithium iron phosphate. In other embodiments, a lithium nickel manganese cobalt oxide (NMC) with more than 50% of the nickel manganese cobalt oxide being nickel.

Yet another aspect of the disclosure provides for manufacturing a composite cathode. A polymer electrolyte according to the various embodiments as described above is prepared. The polymer electrolyte is mixed with a cathode active material, a carbon containing material, and a polyvinylidene difluoride binder binding the cathode active material, the carbon-containing material, and the polymer electrolyte; the cathode active material, the carbon-containing material, the polyvinylidene difluoride binder, and the polymer electrolyte are then formed as a cathode film; the cathode film is then formed on a current collector. In some embodiments, the cathode film layer and the current collector are calendared to increase the density of the cathode film layer to 1.7 g/cm³.

One aspect of the disclosure also provides for a method of manufacturing a polymer electrolyte separator. A polymer electrolyte according to the various embodiments as described above is prepared. The polymer electrolyte is then cast onto the composite cathode manufactured using the method described above. The polymer electrolyte separator can also be separately formed and then integrated with the composite cathode by dry placement.

Another aspect of the disclosure is related to an electrode sub-stack that includes the composite cathode and the polymer electrolyte separator, each with various embodiments of the polymer electrolyte as described above. The electrode sub-stack also includes an anode layer formed on a negative current collector to form an anode. The anode, polymer electrolyte separator, and composite cathode together form the electrode sub-stack.

Another aspect of the disclosure provides for a rechargeable battery cell with a composite cathode including a cathode layer formed on a first current collector, where the composite cathode is according to various embodiments of the polymer electrolyte as described above; an anode layer formed on a second current collector to form a negative electrode where the anode layer is a lithium metal; a polymer electrolyte separator according to various embodiments of the polymer electrolyte as described above, the polymer electrolyte separator separating the positive electrode and the negative electrode. The positive electrode, negative electrode, and polymer electrolyte separator are solid. In some embodiments, the rechargeable battery cell does not contain any liquid electrolyte.

These and other aspects are described further below with reference to the figures.

### BRIEF DESCRIPTION OF THE DRAWINGS

FIG. 1 is a flow chart showing the steps of preparing a polymer electrolyte and preparing a composite cathode based on the polymer electrolyte according to an embodiment of the present disclosure.

FIG. 2A is a perspective view illustrating the preparation of a polymer electrolyte mixture according to an embodiment of the present disclosure.

FIG. 2B is a perspective view illustrating the preparation of a slurry mixture to form a composite cathode according to an embodiment of the present disclosure.

FIG. 2C is a perspective view illustrating the solution casting and doctor blading of a slurry mixture to form a composite cathode according to an embodiment of the present disclosure.

FIG. 2D is a side view illustrating the solution casting and doctor blading of a slurry mixture to form a composite cathode according to an embodiment of the present disclosure.

FIG. 2E illustrates the slurry mixture on the composite cathode after doctor blading according to an embodiment of the present disclosure.

FIG. 2F illustrates the calendaring of the composite cathode according to an embodiment of the present disclosure.

FIG. 2G is a perspective view illustrating the solution casting of a polymer electrolyte separator using the polymer electrolyte according to an embodiment of the present disclosure.

FIG. 2H is a side view illustrating the doctor blading of the solution cast polymer electrolyte separator according to an embodiment of the present disclosure.

FIG. 3A illustrates a rechargeable battery cell according to an embodiment of the present disclosure.

FIG. 3B illustrates an example of a cross-sectional structure of the rechargeable battery cell according to an embodiment of the present disclosure.

FIG. 3C illustrates an example of a perspective view of the rechargeable battery cell according to an embodiment of the present disclosure.

FIG. 4A is a perspective view illustrating a polymer electrolyte according to an embodiment of the present disclosure.

FIG. 4B is a perspective view illustrating a polymer electrolyte according to an embodiment of the present disclosure.

FIG. 4C is a perspective view illustrating a polymer electrolyte according to an embodiment of the present disclosure.

FIG. 4D is a perspective view illustrating a polymer electrolyte according to an embodiment of the present disclosure.

FIG. 4E is a perspective view illustrating a polymer electrolyte according to an embodiment of the present disclosure.

FIG. 5 is a chart showing linear sweep voltammetry (LSV) measurement of the salt in polymer electrolyte according to one embodiment of the present disclosure where the PEST concentration was 80 wt %, the LiTFSI concentration 18 wt %, and the LiBF₄ concentration 2 wt %.

FIG. 6 is a chart showing linear sweep voltammetry (LSV) measurement of the salt in polymer electrolyte according to another embodiment of the present disclosure where the PEST concentration was 80 wt %, the LiTFSI concentration 19.75 wt %, and the LiBF₄ concentration 0.25 wt %.

Like reference numerals are used to describe like parts in all figures of the drawings.

### DETAILED DESCRIPTION

The present disclosure is presented to enable one of ordinary skill in the art to make and use the inventions set forth herein and to incorporate these inventions in the context of particular applications. Various modifications, as well as a variety of uses in different applications will be readily apparent to those skilled in the art, and the general principles defined herein may be applied to a wide range of embodiments. Thus, the present disclosure is not intended to be limited to the embodiments presented, but is to be accorded the widest scope consistent with the principles and novel features disclosed herein.

Polymer electrolytes are viable as catholytes and polymer electrolyte separators in solid-state and semi-solid lithium-ion rechargeable batteries. For a polymer electrolyte to be technically and commercially viable, it must demonstrate sufficient ionic conductivity. A polysiloxane Si-tripodand polymer, lithium salts such as lithium bis(trifluoromethanesulfonyl)imide and/or a lithium tetrafluoroborate, and a polyvinylidene difluoride formed as a polymer electrolyte according to embodiments herein exceed the threshold ionic conductivity in a wide temperature range, including at 25° C. Furthermore, the polymer electrolyte of the present disclosure can easily be manufactured into a free-standing membrane, further enhancing its technical and commercial viability as a separator between a cathode and an anode. As a free-standing membrane, the polymer electrolytes of the present disclosure can be manufactured with relative ease through solution casting and dry placement without the need to apply high pressures to the electrolyte material in the manufacturing process. When manufacturing at scale, polymer electrolytes that can form free-standing membranes have significant advantages in roll-to-roll automated manufacturing processes. The quantitative composition of the polymer electrolyte to deliver the required ionic conductivity while still forming a free-standing membrane was determined through testing. The composite cathode and separator were assembled into a rechargeable lithium-ion coin cell and was tested and measured.

### Ionic Conductivity

Ionic conductivity is a performance parameter for a polymer electrolyte, describing the movement of ions through a polymer matrix and governs lithium-ion battery performance. Low ionic conductivity levels can lead to poor battery performance. Low ionic conductivity levels indicate a high degree of crystallinity within the polymer electrolyte. Ionic conductivity values >1×10⁻³ S/cm are highly desirable and are highly unusual for polymer electrolytes at room temperature. For reference purposes, the conventional carbonate based liquid electrolyte with a standard polypropylene (PP) separator achieves an ionic conductivity of approximately 8×10⁻⁴ S/cm. Dry polymer electrolytes that exhibit an ionic conductivity greater than 10⁻⁴ S/cm at room temperature are considered highly coveted, as crossing this threshold generally implies successful room temperature operation at acceptable C-rates (≥0.1 C). But this does not mean that polymer electrolytes exhibiting ionic conductivities lower than 1×10⁻⁴ S/cm are obsolete.

Depending on the polymer electrolyte, the slight application of heat can increase ionic conductivity to levels suitable for successful operation at higher C-rates. For example, a polymer electrolyte exhibiting an ionic conductivity at 1×10⁻⁵ S/cm at room temperature may exhibit an ionic conductivity greater than 1×10⁻⁴ S/cm at temperatures exceeding 50° C. For applications where a heat source is available or heat is generated as a function of the operation of battery pack and overall device, such as electric vehicles, a polymer electrolyte with lower than 10⁻⁴ S/cm conductivity would have great commercial interest. Therefore, dry polymer electrolytes that have ionic conductivity values greater than 1×10⁻⁵ S/cm at room temperature are technically and commercially viable.

Ionic conductivity in the working examples of the present disclosure described below were tested using electrochemical impedance spectroscopy over a temperature ranging from 25° C. to 80° C. The frequency ranges were from 100 MHz to 1 MHz with an AC amplitude of 10 mV. Ionic conductivity (a) was calculated using the following equation:

### Equation (1):

$$σ = \frac{t}{A \times R}$$

In equation (1), t is the thickness of the polymer electrolyte, A is the area of the stainless steel electrode, and R is the bulk resistance (determined through EIS (Electrochemical Impedance Spectroscopy)).

A technically and commercially viable polymer electrolyte for rechargeable batteries must not only meet the required ionic conductivity, but it must also form a free-standing membrane such as those according to embodiments of the present disclosure described herein. A free-standing membrane has the mechanical properties required to function as a composite cathode or a separator in a solid-state battery cell. A free-standing membrane is not gel like. It is also not viscous and it is non-flowable. It is pliable when a normalized force and pressure is applied but retains its x-y dimension. As a free-standing membrane, it also stands in a form that does not require another substrate to provide structural support.

A free-standing membrane can be formed into large film-like sheets that can be manufactured at scale in automated equipment and processed into rolls. This brings significant advantages for manufacturing complete lithium-ion batteries in a roll-to-roll process. Free-standing membranes manufacturable into large film-like sheets can also be easily cut down to the appropriate size and/or shape for integration into a rechargeable lithium-ion cell.

A free-standing membrane can also be integrated into a rechargeable battery cell with other components such as the cathode and anode without the application of additional pressure or other methods to adhere the membrane to a substrate. A polymer electrolyte separator that is a free-standing membrane can be integrated with a cathode layer through dry placement even though it can also be integrated through solution casting.

Comb polymers, specifically polysiloxanes, have excellent characteristics for use in forming a polymer electrolyte. Polysiloxanes have low glass transition temperatures Tg, which results in increased ionic conductivity. Polysiloxanes are safe because they are intrinsically nonflammable, non-toxic, and non-combustible. Furthermore, polysiloxanes have high oxidative capability, which means that polysiloxanes are voltage stable. This is because polysiloxanes have an inorganic backbone. Generally, polysiloxanes can exhibit voltages exceeding 5V due to their inorganic backbone. Polysiloxanes are also highly customizable through grafting. Finally, polysiloxanes are highly stable when used in conjunction with lithium-metal anodes. Polysiloxanes also have some characteristics that can be further improved upon. Polysiloxanes' silicon backbone is insulating and polysiloxanes also exhibit poor dissolution of lithium cations. The electrochemical performance of polysiloxanes can be greatly improved through grafting.

A polysiloxane Si-tripodand polymer (“PEST”) is formed by modifying polysiloxane polymers through the grafting of electroactive organic polyether chains. The PEST is a viscous gel and when lithiated and dispersed in an organic solvent, experiences high ionic conductivity (>10⁻⁴ S/cm) at room temperature. The synthesized PEST has a structure as illustrated in the diagram below:

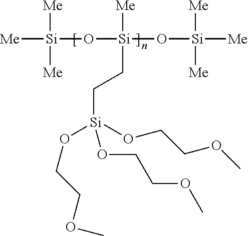

The process for the synthesis of the PEST is illustrated in part in the diagram below:

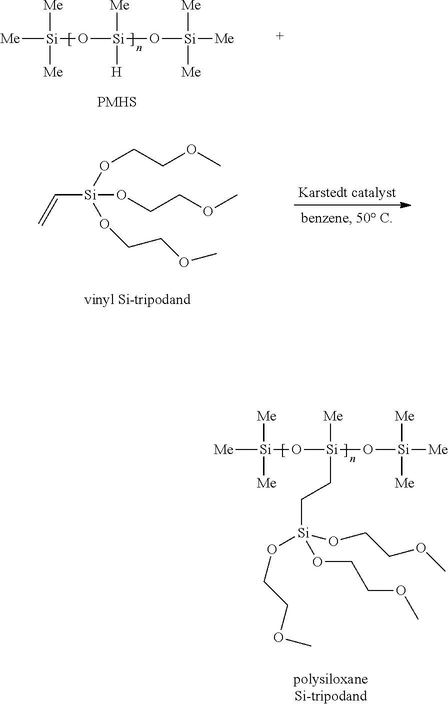

In a first example of the synthesis of the PEST, 5 grams of polymethylhydrosiloxane (PMHS) was measured out in a 50 ml round-bottom flask. A magnetic stir bar was prepared. After placing the PMHS under nitrogen flow, 5 ml of benzene was added via syringe. The reaction was sparged with nitrogen for 15 minutes. Vinyl si-tripodand was added via syringe, and the reaction was sparged with nitrogen for an additional 30 minutes. 0.001 ml of a Karstedt catalyst (2% in xylene) was added. Bubbling was observed. The reaction was further sparged for 20 minutes, sealed with parafilm, and placed in an oil bath at 50° C. for three days. The magnetic stir bar was removed. The benzene was also removed under reduced pressure. The result was a gel having a grayish color.

In a second example of the synthesis of the PEST, 2.5 grams of polymethylhydrosiloxane (PMHS) and 10.5 ml of vinyl si-tripodand were measured out in a 25 ml round-bottom flask. A magnetic stir bar was prepared. The magnetic stir bar was further equipped with a drying tube to reduce moisture in the reaction system. 2.5 ml of benzene was added via syringe. The reaction was sparged with nitrogen for 15 minutes. Vinyl si-tripodand was added via syringe. 0.001 ml of a Karstedt catalyst (2% in xylene) was added and the mixture placed in an oil bath at 50° C. The reaction was monitored with 1H NMR daily for four days. At 20 hours, resonances from the vinyl group remained. On day 2, there were still some vinyl groups remaining, so an additional 0.001 mL Karstedt catalyst was added. On day 3, still some vinyl groups remained, so 0.246 g of PMHS was added. On day 4, all vinyl groups were removed. The magnetic stir bar and drying tube were removed. The benzene was removed under reduced pressure. The result was a clear gel having no color.

A lithium salt or a combination of lithium salts is added to the PEST to formulate the polymer electrolyte. Different lithium salts can be combined with the PEST to achieve the desired ionic conductivity for the polymer electrolyte. LiTFSI and LiBF₄ can increase ionic conductivity. LiTFSI and LiBF₄ can also be used to produce mechanically stable membranes.

The electrochemical stability window (ESW) is another important parameter that determines whether polymer electrolytes can be practically used for Li-ion batteries. The charge and discharge characteristics of electrode materials are within a specific voltage range, and the polymer electrolyte needs to be stable within this voltage range. If not, the polymer electrolyte will be subject to side reactions and thus not be capable of maintaining normal battery operation. The maximum voltage of cathode materials such as lithium iron phosphate (“LFP”), NMC622, and NMC811 is less than 4.3V. A nickel manganese cobalt oxide cathode material with a nickel, manganese, and cobalt content of 60%, 20%, and 20% respectively is commonly known as NMC622. A nickel manganese cobalt oxide cathode material with a nickel, manganese, and cobalt content of 80%, 10%, and 10% respectively is commonly known as NMC811. However, battery chemistries consisting of a Li-metal anode exhibit higher charge windows and will likely increase to greater than 4.5V. Therefore, a polymer electrolyte that can operate from 0 to 5V vs. Li/Li+ would be ideal. Early polymer electrolytes based on PEO are not capable of exceeding 4V, thus limiting the cathode options to LFP. An ESW stable up to 4.7V may be acceptable for LFP and NMC cathodes.

A linear sweep voltammetry (LSV) measurement of a polymer electrolyte is used to determine its ESW. The ESW is determined by observing the flat areas between both major peaks of a linear sweep voltammetry (LSV) measurement.

### The Salt in Polymer Electrolyte Embodiment

One embodiment of the present disclosure is the Salt in Polymer Electrolyte (SiPE) embodiment. The SiPE comprises the PEST as a polymer host and dual lithium salts. At least the first lithium salt is a perfluorinated lithium salt, including lithium bis(fluorosulfonyl)imide (“LiFSI”), lithium bis(pentafluoroethanesulfonyl)imide (“LiBETI”), and lithium bis(trifluoromethanesulfonyl)imide (“LiTFSI”). The second lithium salt is a LiBF₄. In a preferred embodiment, the dual lithium salt is a LiTFSI and a LiBF₄.

The SiPE is majority comprised of the polymer PEST and minority comprised of the dual lithium salt. Its composition can be expressed as:

y(PEST)+z(a·LiTFSI+b·LiBF₄)

y, z, a and b are concentrations in weight percentages. y can range from 70 wt % to 90 wt % and z can range from 10 wt % to 30 wt %. The LiTFSI concentration a can range from 8.0 wt % to 29.75 wt %. The LiBF₄ concentration b can range from 0.25 wt % to 3.0 wt %. These concentration ranges were determined through testing.

In the SiPE, the amount of PEST, LiTFSI, and LiBF₄ must be controlled to achieve the required ionic conductivity while forming a free-standing membrane. Generally, PEST, LiTFSI, and LiBF4 have the following effects on forming a polymer electrolyte membrane:

| Characteristic | Effect on Polymer Electrolyte Membrane |
|---|---|
| Too much LiBF4 or | Membrane becomes brittle, shatters and breaks |
| too little LiTFSI | upon application of a normalized force, not |
| | mechanically stable |
| Too much LiTFSI or | Membrane becomes tacky, cannot be peeled and |
| too little LiBF4 | very soft, tears easily, not mechanically |
| | stable |
| Too little PEST | Membrane becomes wet, cannot be handled nor |
| | shaped, not mechanically stable |
| Too much PEST | Membrane non-conductive, ionic conductivity |
| | falls below 10⁻⁵ S/cm at room temperature |

LiBF4 allows for the formation of a mechanically stable free-standing membrane. As explained above, PEST is a viscous gel at room temperature. The addition of LiBF₄ allows the gel to form into a solid. But too much LiBF4 impedes the formation of a free-standing membrane. The BF₄⁻ anion in LiBF₄ has a small atomic volume. Because of this, it can be trapped in the ethylene oxide chains of the PEST polymer. This causes the resultant polymer electrolyte membrane to harden. Thus, excessive amounts of LiBF₄ can cause a polymer electrolyte membrane to become extremely brittle, hard, and nonflexible.

Furthermore, LiBF₄ is generally not as ionic conductive as other fluorinated based lithium-salts such as LiTFSI. Therefore, to increase sufficient ionic conductivity, LiTFSI is added. The TFSI− anion is stabilized by strong electron-withdrawing groups and a lone nitrogen atom. LiTFSI also dissociates well in low dielectric constant solvents, leading to higher dissociation and increased ionic conductivity. At the same time, the bulker anion size reduces the glass transition temperature of the polymer electrolyte and contributes negatively to the formation of a solid membrane. Hence, excessive levels of LiTFSI prevent formation of free-standing membranes.

### The Polymer in Salt Electrolyte Embodiment

A second embodiment of the present disclosure is the Polymer in Salt Electrolyte (PiSE). The PiSE comprises the PEST and a perfluorinated lithium salt, including LiFSI, LiBETI, and LiTFSI, mixed with a polyvinylidene difluoride (PVDF). In one embodiment, the PVDF is a PVDF(534K). In another embodiment, the PVDF is a PVDF(700K). In yet another embodiment, the PVDF is a PVDF(HSV900).

The PiSE is majority comprised of the PVDF and lithium salt mixture and minority comprised of the PEST. Its composition can be expressed as:

y(a·PVDF:b·LiTFSI)+z(PEST)

Here, y and z are concentrations in weight percentages, and a:b is a ratio. y ranges from 70 wt % to 95 wt % and z ranges from 5 wt % to 30 wt %. The a:b ratio can vary between 50:50 to 35:65.

### Preparation of Polymer Electrolyte Solution and Composite Cathode

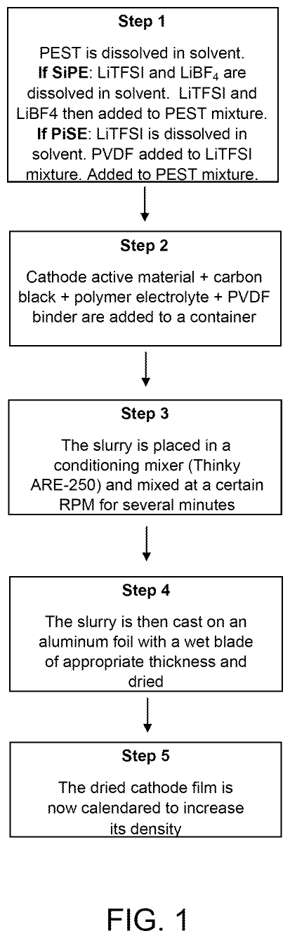

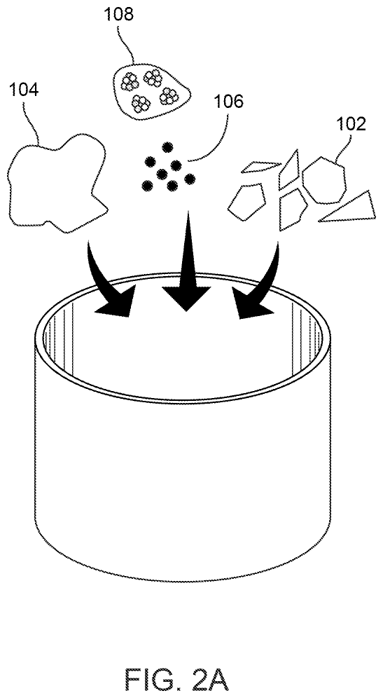

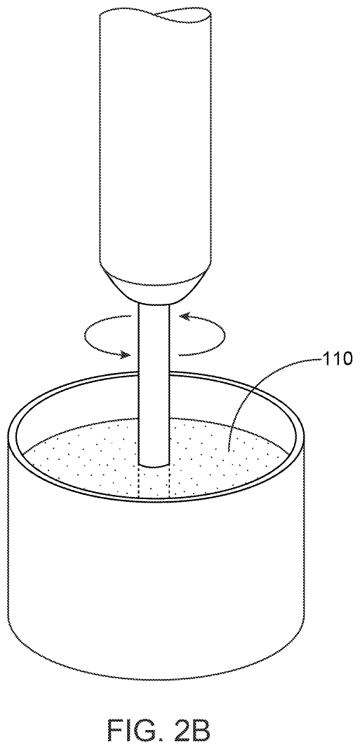

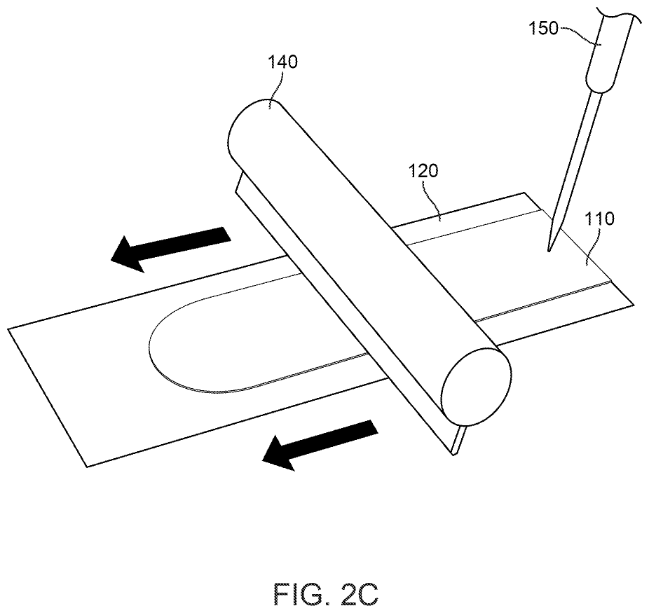

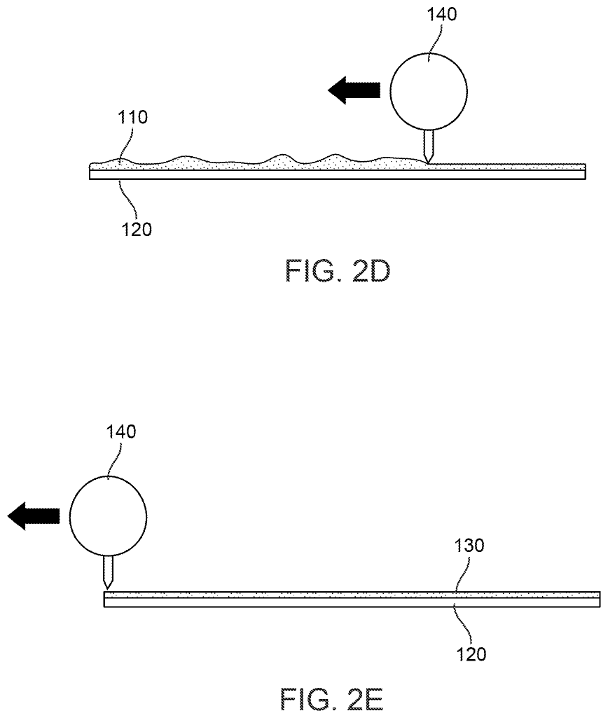

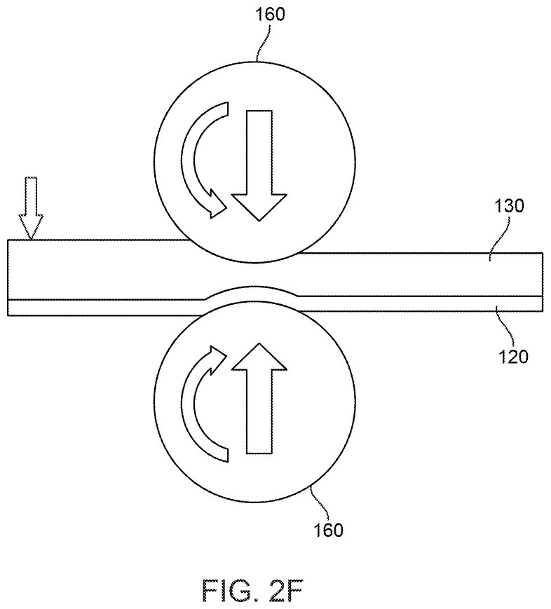

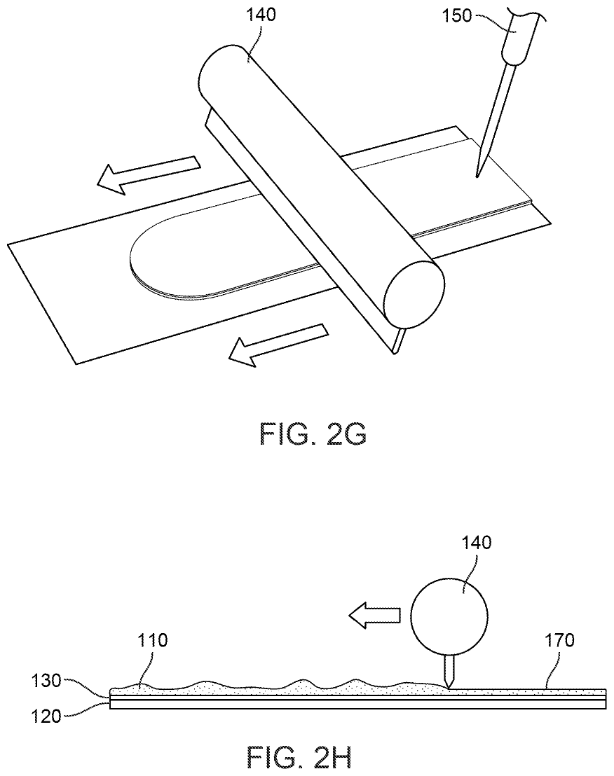

Next, an example of preparing a polymer electrolyte and a composite cathode according to an embodiment of the present disclosure will be described in relation to FIGS. 1 and 2A-2H.

FIG. 1 is a flow chart illustrating the steps of preparing a polymer electrolyte and preparing a composite cathode based on the polymer electrolyte according to an embodiment of the present disclosure. In Step 1, the polymer electrolyte mixture is prepared. In Step 2, the polymer electrolyte is mixed with a cathode active material and other components to form a slurry. In Step 3, the slurry is mixed. In Step 4, the slurry is solution cast onto a current collector to form a composite cathode film. In Step 5, the solution casted composite cathode film is calendared.

FIG. 2A is a perspective view illustrating the preparation of a polymer electrolyte. This corresponds to Step 1 of FIG. 1. In a first container, a polymer PEST is dissolved in an organic solvent, such as acetonitrile, N-methyl-2-pyrrolidone (NMP), or cyclohexanone. The PEST mixture is heated and agitated to promote the dissolution of the PEST in the organic solvent.

In the SiPE embodiment, a first lithium salt, a LiTFSI and a second lithium salt, a LiBF₄, are dissolved in an organic solvent to form a dual lithium salt mixture. The dual lithium salt mixture is then added to the PEST mixture. All components are mixed under heat until a homogenous mixture is obtained. The concentrations of LiTFSI, LiBF₄, and PEST added are expressed as a weight percentage (wt %) of the LiTFSI, LiBF₄, and PEST added according to various embodiments of the present disclosure.

In the PiSE embodiment, a lithium salt, a LiTFSI, is dissolved in an organic solvent to form a lithium salt mixture. A polyvinylidene difluoride (PVDF) is then added to the lithium salt mixture. The lithium salt and PVDF mixture is then added to the PEST mixture. All components are mixed under heat until a homogenous mixture is obtained. The concentrations of LiTFSI, PVDF, and PEST added are expressed as a weight percentage (wt %) of the LiTFSI, PVDF, and PEST added according to various embodiments of the present disclosure.

FIG. 2B is a perspective view illustrating the preparation of a slurry mixture for forming a polymer electrolyte composite cathode. FIG. 2B corresponds to Step 2 and Step 3 of FIG. 1. A cathode active material, carbon black, polyvinylidene difluoride (PVDF) binder, and the polymer electrolyte mixture are mixed in a container to form a slurry 110. 70% cathode active material, 10 wt % carbon black, 15 wt % polymer electrolyte, and 5 wt % PVDF can be used in the slurry mixture. The slurry is transferred to a conditioning mixer (e.g., a Thinky ARE-250) and mixed at certain revolutions per minute (RPM) for several minutes until the mixture is homogenous. The polymer electrolyte function as a catholyte in the composite cathode.

FIG. 2C is a perspective view illustrating the solution casting and doctor blading of a slurry mixture to form the composite cathode. This corresponds to Step 4 of FIG. 1. The slurry 110 is cast onto a current collector 120 that is 16 μm thick with an applicator 150. Suitable current collectors include aluminum current collectors, although copper based current collectors such as copper foils can be used. The organic solvent, in this example NMP, is evaporated until a dense, dry, and black film remains. Although the organic solvent can be removed by evaporation, removal of a solvent is not limited to evaporation. Other methods of removing a solvent include distillation, filtration, extraction, crystallization, centrifugation, and adsorption. A doctor blade 140 is then applied to the cast slurry mixture to flatten the slurry mixture 110 onto the current collector 120, resulting in a composite cathode film 130 (FIG. 2E). The doctor blade 140 should be a wet blade of appropriate thickness. FIG. 2D is a side view illustrating the solution casting and doctor blading of the slurry mixture 110 to form the composite cathode film 130 (FIG. 2E). The doctor blade 140 moves across the solution cast slurry mixture 110 to flatten the slurry mixture. FIG. 2E is a side view illustrating the slurry mixture 110 on the current collector 120 after doctor blading to form the cathode film 130. The composite cathode film is then heated to 60° C. to remove any remaining solvent in the slurry mixture.

FIG. 2F illustrates the calendaring of the composite cathode film. This corresponds to Step 5 of FIG. 1. The composite cathode film 130 and current collector 120 are fed through a set of rollers 160. The rollers 160 together rotate in their respective directions as indicated by the arrows to draw in the composite cathode film 130 and current collector 120 and apply a compressing force to calendar the cathode film 130 and current collector 120. The cathode film 130 is calendared to increase its density to 1.7 g/cm³.

### Preparation of Polymer Electrolyte Separator

Next, an example of a polymer electrolyte separator formed using the polymer electrolyte of the present disclosure will be described in relation to FIGS. 2G and 2H.

FIG. 2G is a perspective view illustrating the solution casting of a polymer electrolyte separator using the polymer electrolyte, according to an embodiment of the present disclosure. The polymer electrolyte mixture 110 is solution cast onto the composite cathode film 130 formed as explained above with reference to FIG. 2F, by means of an applicator 150. One example of an applicator is a dropper, but any device by which a small amount of the mixture 110 can be applied to the composite cathode 100 and then dispersed can be used. FIG. 2H is a side view illustrating the doctor blading of the solution cast polymer electrolyte separator, according to an embodiment of the present disclosure. Once the mixture 110 is cast onto the formed composite cathode film 130, a doctor blade 140 is used to spread the mixture 110 to form an even layer over the entire surface of the composite cathode film 130. The organic solvent in the mixture 110 is allowed to evaporate, forming a polymer electrolyte layer 170. When formed in this manner, the polymer electrolyte layer 170 fuses with the composite cathode film 130 and does not misalign or detach.

The solution cast method for casting a polymer electrolyte as a separator according to the embodiment of the present disclosure described herein has several benefits. First, as between an electrode and the polymer electrolyte, the electrode-electrolyte interfacial impedance is very low. This is because the polymer electrolyte is in direct contact with the electrode. This is regardless of whether the electrode that the polymer electrolyte is solution cast onto is a cathode or an anode. Polymer electrolytes that are directly cast onto the cathode can exhibit better electrochemical performance at higher C-rates. Second, it is a scalable and cost effective method to integrate polymer electrolyte films into solid-state batteries. However, the polymer electrolyte separator of the present disclosure can also be cast onto a separate substrate, peeled off, and then dry placed onto the composite cathode film.

Solution casting the polymer electrolyte as a separator is not limited to forming a single polymer electrolyte layer. The solution casting method can be repeated multiple times to form a separator comprising multiple polymer electrolyte separator layers. Depending on the overall cell design, multiple polymer electrolyte layers can be formed to create a separator of 100 μm or greater to improve performance of separator function to protect against penetration of the separator by dendrites.

The polymer electrolyte present in the composite cathode functioning as a catholyte and the polymer electrolyte separator have the same ionic conductivity. Although the polymer electrolyte separator is formulated with the same polymer electrolyte embodiment as used in the composite cathode, the polymer electrolyte separator is not limited to the same embodiment and can be formulated with a polymer electrolyte of a different embodiment in the present disclosure.

### Lithium-Ion Rechargeable Cell

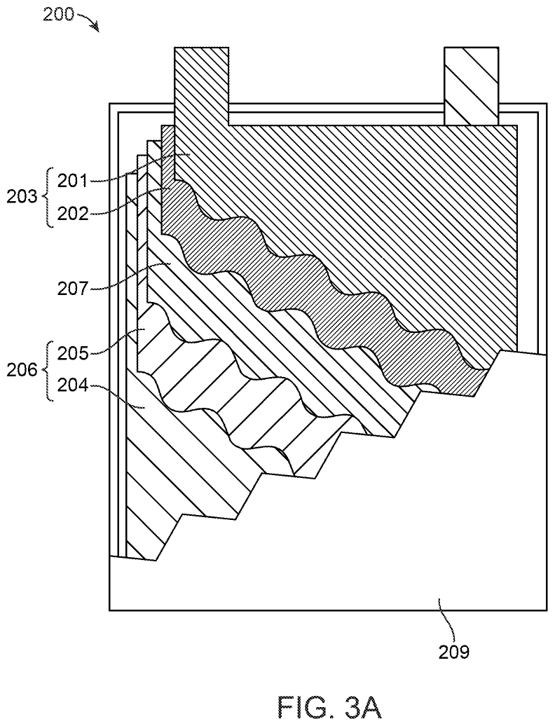

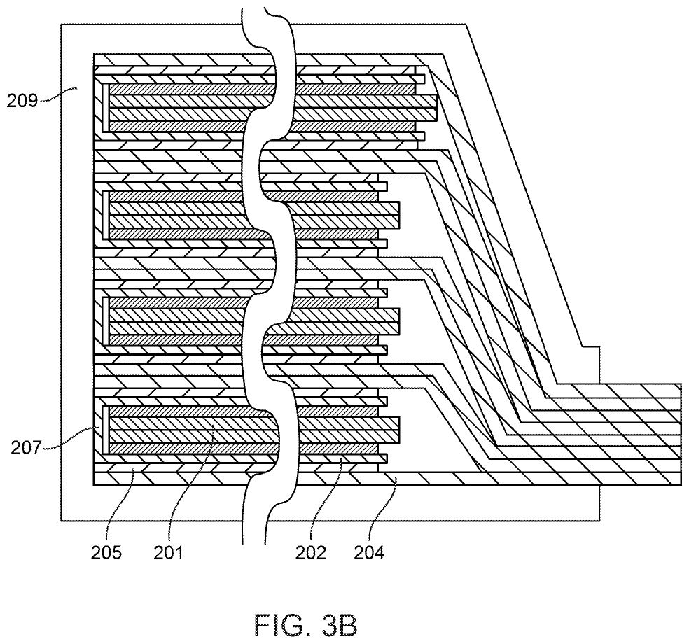

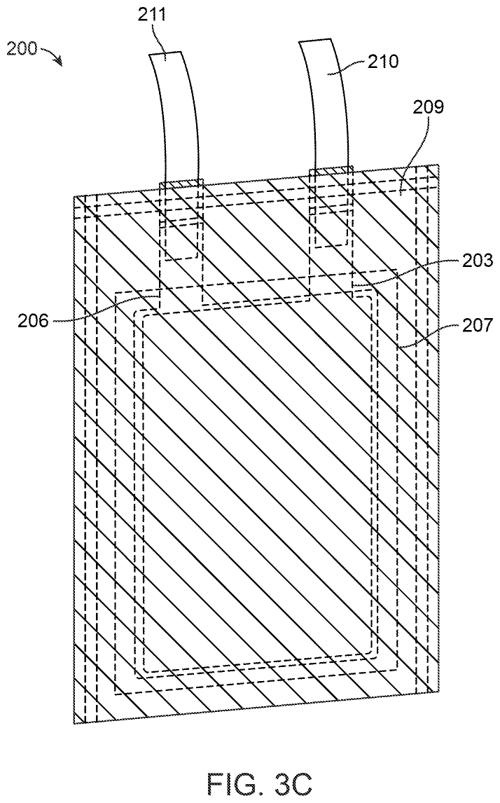

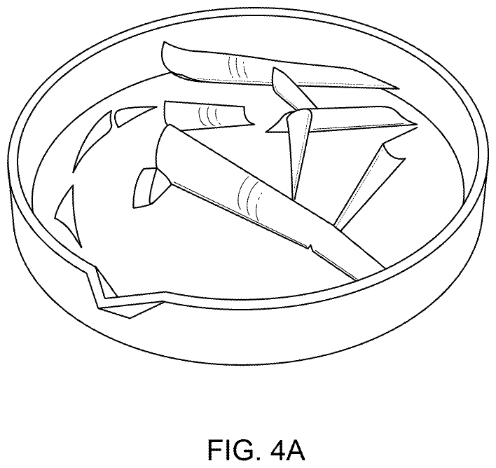

Next, an example of a rechargeable battery cell using the composite cathode, and the polymer electrolyte separator according to embodiment of the present disclosure will be described in relation to FIGS. 3A-3C.

FIG. 3A illustrates a rechargeable battery cell 200 according to embodiment of the present disclosure. The cell 200 includes a cathode current collector 201, a composite cathode film 202, an anode current collector 204, and an anode active material layer 205. The composite cathode film 202 and the cathode current collector 201 together form the composite cathode 203. The anode active material layer 205 and the anode current collector 204 together form the anode 206. A polymer electrolyte separator 207 separates the composite cathode 203 and the anode 206. In one example, the composite cathode 203 is cut to 50 mm×34 mm in size and the anode 206 is cut to 49 mm×33 mm in size. The composite cathode 203 is intentionally cut so that it is larger than the anode 206 to prevent an internal short circuit due to contact of the cathode with the anode.

In FIG. 3A, cathode current collector 201 and the anode current collector 204 also serve as terminals for electrical contact with an external portion. For this reason, the cathode current collector 201 and the anode current collector 204 may be arranged so as to be partly exposed to the outside of the exterior body 209. Alternatively, the cathode current collector 201 or the anode current collector 204 may be bonded to each other by ultrasonic welding, and instead of the positive electrode current collector 201 and the negative electrode current collector 204, the lead electrode may be exposed to the outside of the exterior body 209.

In some embodiments, non-conductive inserts (not shown in FIGS. 3A and 3B) are added at each end of the stack of the rechargeable battery cell. The non-conductive inserts add mechanical rigidity to the stack. A polyolefin film (not shown) can also be tightly wrapped around the stack to ensure that the components of the stack do not shift and remain in interfacial contact with each other.

As the exterior body 209 of the rechargeable battery cell 200, for example, a laminate film having a multi-layer structure can be employed in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body.

FIG. 3B illustrates an example of a cross-sectional structure of the rechargeable battery cell 200. Although FIG. 3A illustrates an example including only two current collectors for simplicity, an actual battery includes a plurality of electrode stacks. The example in FIG. 3B includes 16 electrode layers. The rechargeable battery cell 200 has flexibility even though it includes 16 electrode layers. FIG. 3B illustrates a structure including 8 layers of anode current collectors 204 and 8 layers of cathode current collectors 201, i.e., 16 layers in total. Although FIG. 3B illustrates a cross section of the lead portion of the negative electrode, and the 8 anode current collectors 204 are bonded to each other by ultrasonic welding, the number of electrode layers is not limited to 16, and may be more than 16 or fewer than 16. With a large number of electrode layers, the rechargeable battery cell can have a higher capacity. In contrast, with a small number of electrode layers, the rechargeable battery can be thinner and have greater flexibility.

FIG. 3C illustrates an example of a perspective view of the rechargeable battery cell 200. As shown in FIG. 3C, a nickel tab 210 is welded onto the composite cathode 203 and a nickel tab 211 is also welded onto the anode 206. The weld and internal/external tab portions can be covered with Kapton tape (not shown) to prevent a short-circuit.

### Summary of Examples 1-1 Through 1-32 (Variant #1 SiPE)

In examples 1-1 through 1-32 described below, a series of polymer electrolyte compositions with varying amounts of PEST, LiTFSI, and LiBF₄ were formulated into a polymer electrolyte composite cathode and a polymer electrolyte separator, according to various embodiments of the present disclosure, and were tested.

### Examples 1-1 and 1-2

In Examples 1-1 and 1-2 a polymer electrolyte was prepared using the method for preparation of a polymer electrolyte mixture of the present disclosure. In a first container, PEST was dissolved in an organic solvent NMP. The PEST mixture was heated and agitated to promote the dissolution of the PEST in the organic solvent. A first lithium salt, a LiTFSI, and a second lithium salt, a LiBF₄, were dissolved in an organic solvent to form a dual lithium salt mixture. The dual lithium salt mixture was then added to the PEST mixture. The PEST, LiTFSI, and LiBF₄ mixture was then mixed under heat until all components were homogenously distributed. In Example 1-1, the PEST concentration in the example was 90.0 wt %, the LiTFSI concentration was 9.9 wt %, and the LiBF₄ concentration was 0.1 wt %. In Example 1-2, the PEST concentration in the example was 90.0 wt %, the LiTFSI concentration was 9.875 wt %, and the LiBF₄ concentration was 0.125 wt %.

In both Examples 1-1 and 1-2, attempts were made to form a composite cathode following the method of preparation of the polymer electrolyte composite cathode of the present disclosure. Attempts were also made to form a polymer electrolyte separator layer using the method for preparing a solid polymer electrolyte separator of the present disclosure.

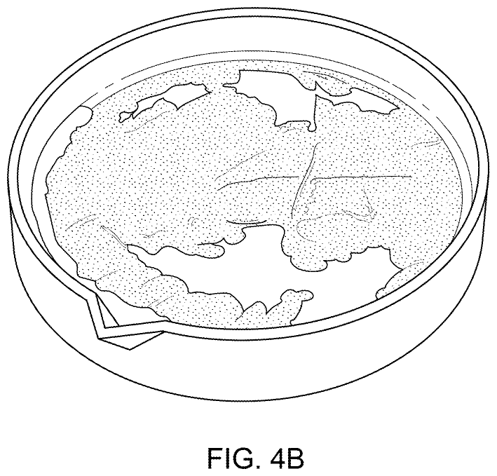

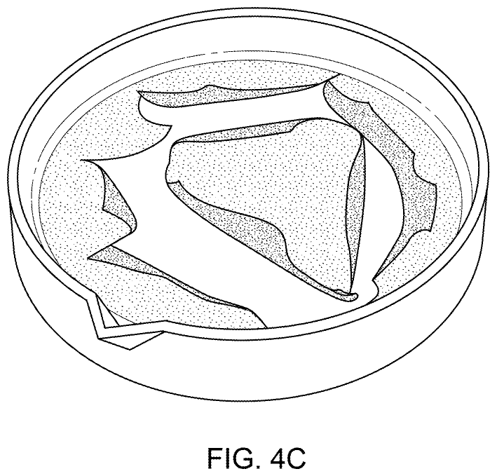

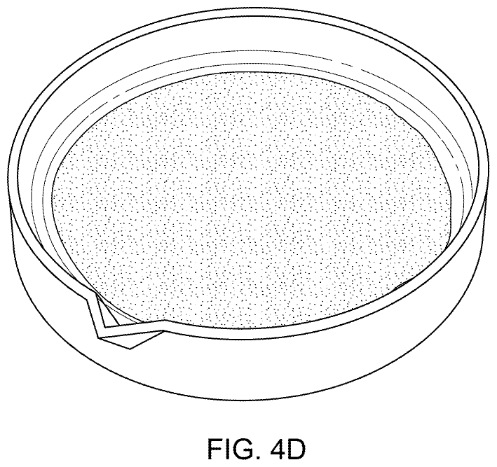

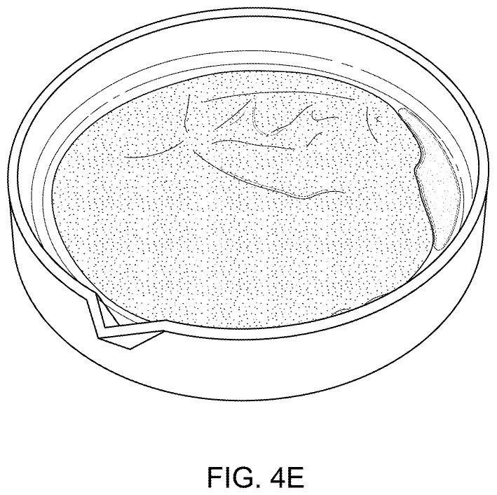

In both Examples 1-1 and 1-2, the polymer electrolyte failed to form a mechanically stable composite cathode and a mechanically stable polymer electrolyte separator film. The formed membranes were tacky, difficult to peel, and tore easily, similar to the membrane in FIG. 4B. The ionic conductivity of the membranes could not be measured.

### Example 1-3

In Example 1-3, a polymer electrolyte was prepared using the method for preparation of a polymer electrolyte mixture of the present disclosure. In a first container, PEST was dissolved in an organic solvent NMP. The PEST mixture was heated and agitated to promote the dissolution of the PEST in the organic solvent. A first lithium salt, a LiTFSI, and a second lithium salt, a LiBF₄, were dissolved in an organic solvent to form a dual lithium salt mixture. The dual lithium salt mixture was then added to the PEST mixture. The PEST, LiTFSI, and LiBF₄ mixture was then mixed under heat until all components were homogenously distributed. The PEST concentration in the example was 90 wt %, the LiTFSI concentration was 9.75 wt %, and the LiBF₄ concentration was 0.25 wt %.

A slurry mixture was prepared following the method of preparation of a slurry mixture of the polymer electrolyte composite cathode of the present disclosure. A cathode active material, carbon black, and polyvinylidene difluoride binder, and the polymer electrolyte mixture were mixed to form a slurry mixture. The slurry was cast onto an aluminum current collector. The organic solvent NMP was evaporated until a dense, dry, and black film remained. The cast slurry mixture was then flattened onto the current collector using a doctor blade to form a cathode film. The cathode film was successfully formed. The cathode film was then calendared to form a composite cathode.

A polymer electrolyte separator layer was prepared using the method for preparing a solid polymer electrolyte separator with the polymer electrolyte of the present disclosure. The polymer electrolyte mixture was solution cast by means of a dropper. After the polymer electrolyte was solution cast, a film applicator, such as a doctor blade, was used to spread the mixture to form a layer. The organic solvent in the polymer electrolyte mixture was removed through evaporation over time. A polymer electrolyte separator film with the characteristics of a free-standing membrane similar to the membrane in FIG. 4D was successfully formed.

The ionic conductivity of the polymer electrolyte separator film was measured at 25° C., 50° C., and 80° C. The polymer electrolyte separator exhibited ionic conductivity of 0.0846×10⁻³ S/cm at 25° C., 0.205×10⁻³ S/cm at 50° C., and 0.388×10⁻³ S/cm at 80° C.

### Example 1-4

In Example 1-4, a polymer electrolyte was prepared using the method for preparation of a polymer electrolyte mixture of the present disclosure. The PEST concentration in the example was 90 wt %, the LiTFSI concentration was 9.5 wt %, and the LiBF₄ concentration was 0.5 wt %. A composite cathode and a polymer electrolyte separator layer were prepared using the method for preparing of the present disclosure. A cathode film was successfully formed and it was calendared to form a composite cathode. A polymer electrolyte separator film was also successfully formed similar to the membrane in FIG. 4D. The polymer electrolyte separator exhibited ionic conductivity of 0.123×10⁻³ S/cm at 25° C., 0.268×10⁻³ S/cm at 50° C., and 0.512×10⁻³ S/cm at 80° C.

### Example 1-5

In Example 1-5, a polymer electrolyte was prepared using the method for preparation of a polymer electrolyte mixture of the present disclosure. The PEST concentration in the example was 90 wt %, the LiTFSI concentration was 9.0 wt %, and the LiBF₄ concentration was 1.0 wt %. A composite cathode and a polymer electrolyte separator layer were prepared using the method for preparing of the present disclosure. A cathode film was successfully formed and it was calendared to form a composite cathode. A polymer electrolyte separator film was also successfully formed similar to the membrane in FIG. 4D. The polymer electrolyte separator exhibited ionic conductivity of 0.0379×10⁻³ S/cm at 25° C., 0.0848×10⁻³ S/cm at 50° C., and 0.139×10⁻³ S/cm at 80° C.

### Example 1-6

In Example 1-6, a polymer electrolyte was prepared using the method for preparation of a polymer electrolyte mixture of the present disclosure. The PEST concentration in the example was 90 wt %, the LiTFSI concentration was 8.0 wt %, and the LiBF₄ concentration was 2.0 wt %. A composite cathode and a polymer electrolyte separator layer were prepared using the method for preparing of the present disclosure. A cathode film was successfully formed and it was calendared to form a composite cathode. A polymer electrolyte separator film was also successfully formed similar to the membrane in FIG. 4D. The polymer electrolyte separator exhibited ionic conductivity of 0.424×10⁻³ S/cm at 25° C., 0.100×10⁻³ S/cm at 50° C., and 0.209×10⁻³ S/cm at 80° C.

### Examples 1-7, 1-8, and 1-9

In Examples 1-7, 1-8, and 1-9 a polymer electrolyte was prepared using the method for preparation of a polymer electrolyte mixture of the present disclosure. In a first container, PEST was dissolved in an organic solvent NMP. The PEST mixture was heated and agitated to promote the dissolution of the PEST in the organic solvent. A first lithium salt, a LiTFSI, and a second lithium salt, a LiBF₄, were dissolved in an organic solvent to form a dual lithium salt mixture. The dual lithium salt mixture was then added to the PEST mixture. The PEST, LiTFSI, and LiBF₄ mixture was then mixed under heat until all components were homogenously distributed. In Example 1-7, the PEST concentration in the example was 90.0 wt %, the LiTFSI concentration was 7.0 wt %, and the LiBF₄ concentration was 3.0 wt %. In Example 1-8, the PEST concentration in the example was 90.0 wt %, the LiTFSI concentration was 5.0 wt %, and the LiBF₄ concentration was 5.0 wt %. In Example 1-9, the PEST concentration in the example was 90.0 wt %, the LiTFSI concentration was 1.0 wt %, and the LiBF₄ concentration was 9.0 wt %.

In all three examples, attempts were made to form a composite cathode following the method of preparation of the polymer electrolyte composite cathode of the present disclosure. Attempts were also made to form a polymer electrolyte separator layer using the method for preparing a solid polymer electrolyte separator of the present disclosure.

In all three examples, the polymer electrolyte failed to form a mechanically stable composite cathode and a mechanically stable polymer electrolyte separator film. The formed membranes were brittle, hard, and nonflexible, similar to the membrane in FIG. 4A. The ionic conductivity of the membranes could not be measured.

### Examples 1-10 and 1-11

Compared to Examples 1-1 through 1-9, starting in Example 1-10 and then followed by Example 1-11, the concentration of PEST was decreased to 80 wt %. The polymer electrolyte was prepared using the same methods as in Examples 1-1 through 1-9. In Example 1-10, the PEST concentration in the example was 80.0 wt %, the LiTFSI concentration was 19.9 wt %, and the LiBF₄ concentration was 0.1 wt %. In Example 1-11, the PEST concentration in the example was 80.0 wt %, the LiTFSI concentration was 19.875 wt %, and the LiBF₄ concentration was 0.125 wt %.

In both examples, attempts were made to form a composite cathode following the method of preparation of the polymer electrolyte composite cathode of the present disclosure. Attempts were also made to form a polymer electrolyte separator layer using the method for preparing a solid polymer electrolyte separator of the present disclosure.

In both examples, the polymer electrolyte failed to form a mechanically stable composite cathode and a mechanically stable polymer electrolyte separator film. The formed membranes were tacky, difficult to peel, and tore easily, similar to the membrane in FIG. 4B. The ionic conductivity of the membranes could not be measured.

### Examples 1-12 Through 1-15

In Examples 1-12 through 1-15, the concentrations of PEST were at 80 wt %. The polymer electrolyte was prepared using the same methods as in Examples 1-1 through 1-9. The LiBF₄ concentration was increased to 0.25 wt % in Example 1-12 from 0.125 wt % in Example 1-11, while the LiTFSI concentration was decreased to 19.75 wt %. The LiBF₄ concentration was then further increased to 0.5 wt %, 1.0 wt %, and 2.0 wt % in Examples 1-13, 1-14, and 1-15, respectively, while the LiTFSI concentration was decreased to 19.5 wt %, 19.0 wt %, and 18.0 wt % in Examples 1-13, 1-14, and 1-15, respectively. A composite cathode and a polymer electrolyte separator layer were prepared using the method for preparing of the present disclosure in all four examples. In all four examples, a cathode film was successfully formed and it was calendared to form a composite cathode. In all four examples, a polymer electrolyte separator film was also successfully formed similar to the membrane in FIG. 4D. In all four examples, the polymer electrolyte separator film exhibited ionic conductivities above the threshold of 1.0×10⁻⁵ S/cm at the measured temperatures of 25° C., 50° C., and 80° C.

### Examples 1-16 and 1-17

In Examples 1-16 and 1-17, the concentrations of PEST were also decreased to 80 wt % compared to Examples 1-7 and 1-8, but had respectively the same concentration of LiBF₄ at 3 wt % and 5 wt %. And like Examples 1-7 and 1-8, an attempt was made to form a composite cathode and a polymer electrolyte separator. The polymer electrolyte failed to form a mechanically stable composite cathode and a mechanically stable polymer electrolyte separator film. The formed membranes were brittle, hard, and nonflexible, similar to the membrane in FIG. 4A. The ionic conductivity of the membranes could not be measured.

### Example 1-19

Example 1-19 is a repeat test of the LiBF₄ concentration of 0.125 wt % like in Examples 1-2 and 1-11 but with PEST lowered to a concentration of 70 wt % and LiTFSI increased accordingly to 29.875 wt %. Like in Examples 1-2 and 1-11, the polymer electrolyte failed to form a mechanically stable composite cathode and a mechanically stable polymer electrolyte separator film. The formed membrane was tacky, difficult to peel, and tore easily, similar to the membrane in FIG. 4B. The ionic conductivity of the membrane could not be measured.

### Examples 1-20 Through 1-23

In Examples 1-20 through 1-23, the concentrations of PEST were decreased to 70 wt % as compared to the Examples 1-3 through 1-6 and Examples 1-12 through 1-15 at the 90 wt % and 80 wt % levels respectively. The polymer electrolyte was prepared using the same methods. The LiBF₄ concentration was set at the same amount as the comparative examples in Examples 1-3 through 1-6 and Examples 1-12 through 1-15 and the LiTFSI concentration was adjusted accordingly to maintain the total wt % of the dual lithium salts at each level. Composite cathodes and polymer electrolyte separator layers were prepared using the method for preparing of the present disclosure in all four examples. In all four examples, a cathode film was successfully formed and it was calendared to form a composite cathode. In all four examples, a polymer electrolyte separator film was also successfully formed similar to the membrane in FIG. 4D. In all four examples, the membranes exhibited ionic conductivities above the threshold of 1.0×10⁻⁵ S/cm at the measured temperatures of 25° C., 50° C., and 80° C.

### Examples 1-24

In Example 1-24, the concentration of PEST was set to 70 wt %. The LiBF₄ concentration was set at 3.0 wt % and the LiTFSI concentration at 27.0 wt %. A composite cathode and a polymer electrolyte separator layer were prepared using the method for preparing of the present disclosure. A cathode film was successfully formed and it was calendared to form a composite cathode. A polymer electrolyte separator film was also successfully formed similar to the membrane in FIG. 4D. The membranes exhibited ionic conductivities above the threshold of 1.0×10⁻⁵ S/cm at the measured temperatures of 25° C., 50° C., and 80° C.

### Example 1-25

In Example 1-25, the PEST concentration was dropped to 70.0 wt %. The LiBF₄ concentration was set at the 4.0 wt % and the LiTFSI concentration at 26.0 wt %. An attempt was made to form a composite cathode and a polymer electrolyte separator. The polymer electrolyte failed to form a mechanically stable composite cathode and a mechanically stable polymer electrolyte separator film. The formed membrane was brittle, hard, and nonflexible, similar to the membrane in FIG. 4A. The ionic conductivity of the membranes could not be measured.

### Example 1-26

In Example 1-26, the PEST concentration was dropped to 70.0 wt % compared to Example 1-8 at the 90 wt % level and Example 1-17 at the 80 wt % level. But the LiBF₄ concentration was the same at 5 wt %. The LiTFSI concentration was adjusted accordingly to main the total wt % of the dual lithium salt as the 90 wt % and 80 wt % levels. Like Examples 1-8 and Example 1-17, an attempt was made to form a composite cathode and a polymer electrolyte separator. The polymer electrolyte failed to form a mechanically stable composite cathode and a mechanically stable polymer electrolyte separator film. The formed membrane was brittle, hard, and nonflexible, similar to the membrane in FIG. 4A. The ionic conductivity of the membranes could not be measured.

### Examples 1-27 Through 1-32

In Examples 1-27 through 1-32, the LiBF₄ concentration levels of Examples 1-19 through 1-23 and 1-25 were repeated but PEST concentrations were decreased to 60.0 wt %. LiTFSI concentrations were increased accordingly. In all examples, an attempt was made to form a composite cathode and a polymer electrolyte separator. The polymer electrolyte failed to form a mechanically stable composite cathode and a mechanically stable polymer electrolyte separator film. The formed membranes were dimensionally unstable and wet, similar to the membrane in FIG. 4C. The ionic conductivity of the membranes could not be measured.

TABLE 1
Summary of Working Examples 1-1 through 1-32

| Working | PEST | LiTFSI | LiBF₄ | Ionic Conductivity (S/cm) | | |
|---|---|---|---|---|---|---|
| Example | (wt %) | (wt %) | (wt %) | 25° C. | 50° C. | 80° C. |
| 1-1 | 90.000 | 9.900 | 0.100 | Failed (tacky) membrane; could not be measured | | |
| 1-2 | 90.000 | 9.875 | 0.125 | Failed (tacky) membrane; could not be measured | | |
| 1-3 | 90.000 | 9.750 | 0.250 | 0.0846 × 10⁻³ | 0.2050 × 10⁻³ | 0.3880 × 10⁻³ |
| 1-4 | 90.000 | 9.500 | 0.500 | 0.1230 × 10⁻³ | 0.2680 × 10⁻³ | 0.5120 × 10⁻³ |
| 1-5 | 90.000 | 9.000 | 1.000 | 0.0379 × 10⁻³ | 0.0848 × 10⁻³ | 0.1390 × 10⁻³ |
| 1-6 | 90.000 | 8.000 | 2.000 | 0.0424 × 10⁻³ | 0.1000 × 10⁻³ | 0.2090 × 10⁻³ |
| 1-7 | 90.000 | 7.000 | 3.000 | Failed (brittle) membrane; could not be measured | | |
| 1-8 | 90.000 | 5.000 | 5.000 | Failed (brittle) membrane; could not be measured | | |
| 1-9 | 90.000 | 1.000 | 9.000 | Failed (brittle) membrane; could not be measured | | |
| 1-10 | 80.000 | 19.900 | 0.100 | Failed (tacky) membrane; could not be measured | | |
| 1-11 | 80.000 | 19.875 | 0.125 | Failed (tacky) membrane; could not be measured | | |
| 1-12 | 80.000 | 19.750 | 0.250 | 0.2160 × 10⁻³ | 0.6020 × 10⁻³ | 1.4800 × 10⁻³ |
| 1-13 | 80.000 | 19.500 | 0.500 | 0.1090 × 10⁻³ | 0.3070 × 10⁻³ | 0.7730 × 10⁻³ |
| 1-14 | 80.000 | 19.000 | 1.000 | 0.1880 × 10⁻³ | 0.4460 × 10⁻³ | 1.2000 × 10⁻³ |
| 1-15 | 80.000 | 18.000 | 2.000 | 0.2110 × 10⁻³ | 0.5630 × 10⁻³ | 1.6900 × 10⁻³ |
| 1-16 | 80.000 | 17.000 | 3.000 | Failed (brittle) membrane; could not be measured | | |
| 1-17 | 80.000 | 15.000 | 5.000 | Failed (brittle) membrane; could not be measured | | |
| 1-19 | 70.000 | 29.875 | 0.125 | Failed (tacky) membrane; could not be measured | | |
| 1-20 | 70.000 | 29.750 | 0.250 | 0.3090 × 10⁻³ | 1.4900 × 10⁻³ | 2.8600 × 10⁻³ |
| 1-21 | 70.000 | 29.500 | 0.500 | 0.2010 × 10⁻³ | 0.8780 × 10⁻³ | 2.4100 × 10⁻³ |
| 1-22 | 70.000 | 29.000 | 1.000 | 0.0838 × 10⁻³ | 0.6820 × 10⁻³ | 1.9900 × 10⁻³ |
| 1-23 | 70.000 | 28.000 | 2.000 | 0.1130 × 10⁻³ | 0.4520 × 10⁻³ | 1.5200 × 10⁻³ |
| 1-24 | 70.000 | 27.000 | 3.000 | 0.1830 × 10⁻³ | 0.7100 × 10⁻³ | 1.7700 × 10⁻³ |

| | | | | |
|---|---|---|---|---|
| 1-25 | 70.000 | 26.000 | 4.000 | Failed (brittle) membrane; could not be measured |
| 1-26 | 70.000 | 25.000 | 5.000 | Failed (brittle) membrane; could not be measured |
| 1-27 | 60.000 | 39.875 | 0.125 | Failed (wet) membrane; could not be measured |
| 1-28 | 60.000 | 39.750 | 0.250 | Failed (wet) membrane; could not be measured |
| 1-29 | 60.000 | 39.500 | 0.500 | Failed (wet) membrane; could not be measured |
| 1-30 | 60.000 | 39.000 | 1.000 | Failed (wet) membrane; could not be measured |
| 1-31 | 60.000 | 38.000 | 2.000 | Failed (wet) membrane; could not be measured |
| 1-32 | 60.000 | 36.000 | 4.000 | Failed (wet) membrane; could not be measured |

Through Examples 1-1 and 1-2, it was initially determined that at least a LiBF₄ concentration of 0.25 wt % is required to form a free-standing membrane. At LiBF₄ concentrations below 0.25 wt %, the SiPE polymer electrolyte will result in a membrane that is tacky, difficult to peel, and tears easily. This is because when LiBF₄ is too low, there is excessive LiTFSI. LiTFSI's bulker anion size reduces the glass transition temperature of the SiPE polymer electrolyte and contributes negatively to the formation of a solid membrane. Examples 1-10 and 1-11 at the 80 wt % PEST level and Example 1-19 at the 70 wt % PEST level further confirmed that the minimum LiBF₄ concentration is 0.25 wt %.

Examples 1-6 and 1-15 demonstrated that LiBF₄ cannot exceed 2.0 wt % at 90 wt % and 80 wt % PEST respectively. Example 1-24 demonstrated that LiBF₄ cannot exceed 3.0 wt %. Above 2 wt % of LiBF₄, at 90 wt % and 80 wt % PEST, and above 3 wt % of LiBF₄, at 70 wt % PEST, a free-standing membrane will not form, the formed membrane will be brittle, hard, and nonflexible similar to the membrane shown in FIG. 4A.

Examples 1-1 through 1-9 demonstrated that the concentration of PEST cannot exceed 90 wt %. This is because at least 10 wt % concentration must be reserved for the dual lithium salts LiTFSI and LiBF₄, both of which are required to meet the threshold level of ionic conductivity of 1.0×10⁻⁵ S/cm. Examples 1-3 through 1-6, with the lowest levels of LiTFSI compared to Examples 1-12 through 1-15 and Examples 1-20 through 1-23 at the 80 wt % and 70 wt % levels of PEST respectively, exhibited ionic conductivities at 25° C. that only just meet the threshold of 1.0×10⁻⁵ S/cm. Thus, Examples 1-3 through 1-6 confirm that the lithium salt concentration cannot fall below 10 wt %, below which the threshold ionic conductivity cannot be met. Accordingly, the maximum PEST concentration is 90 wt %.

Examples 1-27 through 1-32 demonstrated that the PEST concentration cannot fall below 70 wt %. The primary role of the PEST is to provide a matrix for the lithium-salts to dissociate in while secondarily assisting in lithium-ion transport through the active ethylene oxide group side chains. However, once the PEST concentration falls below a certain level, the polymer mechanically fails by becoming wet and is incapable of dissociating lithium-salts. Examples 1-27 through 1-32 confirmed that at 60 wt % of PEST and below, a free-standing membrane does not form at any combination of LiTFSI and LiBF₄. Thus, the minimum concentration of PEST is 70 wt %.

### Summary of Examples 2-1 Through 2-21 PVDF(534K)

In examples 2-1 through 2-21 described below, a series of polymer electrolyte compositions with varying amounts of PVDF(534K), LiTFSI, and PEST were formulated into a polymer electrolyte composite cathode and a polymer electrolyte separator, according to various embodiments of the present disclosure, and were tested.

### Examples 2-1 Through 2-7

In Examples 2-1 through 2-7, a polymer electrolyte was formulated according to the method of formulating a PiSE electrolyte with a PVDF(534K) according to the present disclosure. In the PiSE electrolyte, the a:b ratio where a is PVDF(534K) and b is LiTFSI was maintained at a 50:50 ratio. The portion of y to z where y is PVDF(534K) and LiTFSI and z is PEST was varied in the examples. In Example 2-1, y was 95 wt % and z was 5 wt %. In Example 2-2, y was decreased to 90 wt % and z was increased to 10 wt %. In Example 2-3, y was decreased to 85 wt % and z was increased to 15 wt %. In Example 2-4, y was decreased to 80 wt % and z was increased to 20 wt %. In Example 2-5, y was decreased to 75 wt % and z was increased to 25 wt %. In Example 2-6, y was decreased to 70 wt % and z was increased to 30 wt %. In Example 2-7, y was decreased to 65 wt % and z was increased to 35 wt %.

A composite cathode and a polymer electrolyte separator layer were prepared using the method for preparing of the present disclosure. In Examples 2-1 through 2-6, a cathode film was successfully formed and it was calendared to form a composite cathode. Examples 2-1 through 2-6, a polymer electrolyte separator film was also successfully formed similar to the membrane in FIG. 4D. In Example 2-7, the cathode film and polymer electrolyte separator were not successfully formed. The formed membrane was wet similar to the membrane in FIG. 4E. The ionic conductivities of the membranes in Examples 2-1 through 2-6 at 25° C., 50° C., and 80° C. were measured and are reported in Table 2. All exceeded the threshold ionic conductivity of 1.0×10⁻⁵ S/cm.

### Examples 2-8 Through 2-13

In Examples 2-8 through 2-13, like in the preceding examples in the example 2 series, a polymer electrolyte was formulated according to the method of formulating a PiSE electrolyte with a PVDF(534K) according to the present disclosure. In these examples of the PiSE electrolyte, the a:b ratio where a is PVDF(534K) and b is LiTFSI was maintained at a 40:60 ratio. The portion of y to z where y is PVDF(534K) and LiTFSI and z is PEST was varied in the examples. In Example 2-8, like in Example 2-1, y was 95 wt % and z was 5 wt %. These concentrations were similarly varied until in Example 2-13 y was 70 wt % and z was 30 wt %.

A composite cathode and a polymer electrolyte separator layer were prepared using the method for preparing of the present disclosure. In Examples 2-8 through 2-11, a cathode film was successfully formed and it was calendared to form a composite cathode. Examples 2-8 through 2-11, a polymer electrolyte separator film was also successfully formed similar to the membrane in FIG. 4D. In Examples 2-12 and 2-13, the cathode films and polymer electrolyte separators were not successfully formed. The formed membranes were wet similar to the membrane in FIG. 4E. The ionic conductivities of the membranes in Examples 2-8 through 2-11 at 25° C., 50° C., and 80° C. were measured and are reported in Table 2. All exceeded the threshold ionic conductivity of 1.0×10⁻⁵ S/cm.

### Examples 2-14 Through 2-17

In Examples 2-14 through 2-17, like in the preceding examples in the example 2 series, a polymer electrolyte was formulated according to the method of formulating a PiSE electrolyte with a PVDF(534K) according to the present disclosure. In these examples of the PiSE electrolyte, the a:b ratio where a is PVDF(534K) and b is LiTFSI was maintained at a 35:65 ratio. The portion of y to z where y is PVDF(534K) and LiTFSI and z is PEST was varied in the examples. In Example 2-14, like in Example 2-1 and 2-8, y was 95 wt % and z was 5 wt %. These concentrations were similarly varied until in Example 2-17 y was 80 wt % and z was 20 wt %.

A composite cathode and a polymer electrolyte separator layer were prepared using the method for preparing of the present disclosure. In Examples 2-14 and 2-15, a cathode film was successfully formed and it was calendared to form a composite cathode. Examples 2-14 and 2-15, a polymer electrolyte separator film was also successfully formed similar to the membrane in FIG. 4D. In Examples 2-16 and 2-17, the cathode films and polymer electrolyte separators were not successfully formed. The formed membranes were wet similar to the membrane in FIG. 4E. The ionic conductivities of the membranes in Examples 2-14 and 2-15 at 25° C., 50° C., and 80° C. were measured and are reported in Table 2. All exceeded the threshold ionic conductivity of 1.0×10⁻⁵ S/cm.

### Examples 2-18 Through 2-21

In Examples 2-18 through 2-21, like in the preceding examples in the example 2 series, a polymer electrolyte was formulated according to the method of formulating a PiSE electrolyte with a PVDF(534K) according to the present disclosure. In these examples of the PiSE electrolyte, the a:b ratio where a is PVDF(534K) and b is LiTFSI was maintained at a 30:70 ratio. The portion of y to z where y is PVDF(534K) and LiTFSI and z is PEST was varied in the examples. In Example 2-14, like in Example 2-1 and 2-8, y was 95 wt % and z was 5 wt %. These concentrations were similarly varied until in Example 2-17 y was 80 wt % and z was 20 wt %.

A composite cathode and a polymer electrolyte separator layer were prepared using the method for preparing of the present disclosure. In all four examples 2-18 through 2-21, the cathode films and polymer electrolyte separators were not successfully formed. The formed membranes were wet similar to the membrane in FIG. 4E.

TABLE 2
Summary of Working Examples 2-1 through 2-21

| Working | | | z | Membrane | Ionic Conductivity (S/cm) | | |
|---|---|---|---|---|---|---|---|
| Examples | a:b | y | (PEST) | Quality | 25° C. | 50° C. | 80° C. |
| 2-1 | 50:50 | 95 | 5 | Good | 0.160 × 10⁻³ | 0.797 × 10⁻³ | 1.380 × 10⁻³ |
| 2-2 | | 90 | 10 | Good | 0.153 × 10⁻³ | 0.514 × 10⁻³ | 0.903 × 10⁻³ |
| 2-3 | | 85 | 15 | Good | 0.114 × 10⁻³ | 0.370 × 10⁻³ | 0.829 × 10⁻³ |
| 2-4 | | 80 | 20 | Good | 0.123 × 10⁻³ | 0.410 × 10⁻³ | 0.712 × 10⁻³ |
| 2-5 | | 75 | 25 | Good | 0.087 × 10⁻³ | 0.294 × 10⁻³ | 0.657 × 10⁻³ |
| 2-6 | | 70 | 30 | Good | 0.062 × 10⁻³ | 0.189 × 10⁻³ | 0.466 × 10⁻³ |
| 2-7 | | 65 | 35 | Fail (Wet) | N/A | N/A | N/A |
| 2-8 | 40:60 | 95 | 5 | Good | 0.461 × 10⁻³ | 1.19 × 10⁻³ | 2.24 × 10⁻³ |
| 2-9 | | 90 | 10 | Good | 0.456 × 10⁻³ | 0.685 × 10⁻³ | 0.596 × 10⁻³ |
| 2-10 | | 85 | 15 | Good | 0.301 × 10⁻³ | 0.871 × 10⁻³ | 1.30 × 10⁻³ |
| 2-11 | | 80 | 20 | Good | 0.243 × 10⁻³ | 0.485 × 10⁻³ | 1.44 × 10⁻³ |
| 2-12 | | 75 | 25 | Fail (Wet) | N/A | N/A | N/A |
| 2-13 | | 70 | 30 | Fail (Wet) | N/A | N/A | N/A |
| 2-14 | 35:65 | 95 | 5 | Good | 0.383 × 10⁻³ | 0.885 × 10⁻³ | 1.43 × 10⁻³ |
| 2-15 | | 90 | 10 | Good | 0.404 × 10⁻³ | 1.01 × 10⁻³ | 1.57 × 10⁻³ |
| 2-16 | | 85 | 15 | Fail (Wet) | N/A | N/A | N/A |
| 2-17 | | 80 | 20 | Fail (Wet) | N/A | N/A | N/A |
| 2-18 | 30:70 | 95 | 5 | Fail (Wet) | N/A | N/A | N/A |
| 2-19 | | 90 | 10 | Fail (Wet) | N/A | N/A | N/A |
| 2-20 | | 85 | 15 | Fail (Wet) | N/A | N/A | N/A |
| 2-21 | | 80 | 20 | Fail (Wet) | N/A | N/A | N/A |

Through Examples 2-1 through 2-21, the composition of PEST, PVDF(534K), and LiTFSI to form a free-standing membrane was determined. The a:b ratio is first fixed at 50:50. From here, y and z are first set at 95 wt % and 5 wt % respectively. y is gradually decreased (which equates to z, PEST increasing) and eventually, the resultant polymer electrolyte will not be mechanical stable and be wet. Once the boundary conditions (range where the mechanical stability of the polymer electrolyte is stable) are determined for that set a:b ratio, the a:b ratio would be adjusted to increase the lithium-salt (decrease the PVDF content). The range for optimal y:z ratios at higher LiTFSI concentrations (b) is limited because of lack of polymer host to dissociate with the polymer electrolyte matrix. Once the a:b formulation reaches 30:70, the polymer host content becomes so low that the lithium-salt cannot dissociate effectively, and a free-standing membrane cannot form regardless of the concentration of PEST.

In Examples 2-1 through 2-7, the PVDF(534K) to LiTFSI ratio was 50:50, it was varied 40:60 in Examples 2-8 through 2-13, 35:65 in Examples 2-14 through 2-17, and 30:70 in Examples 2-18 through 2-21. As the PEST concentration was increased, the film will eventually fail to form a free-standing membrane as it is too wet. The amount of PEST where a free-standing membrane failed to form at each PVDF(534K) to LiTFSI ratio was determined. In Example 2-7, for a ratio of 50:50, at a 35 wt % PEST concentration, a free-standing membrane failed to form. In Example 2-12, for a ratio of 40:60, at a 25 wt % PEST concentration, a free-standing membrane failed to form. In Example 2-16, for a ratio of 35:65, at a 15 wt % PEST concentration, a free-standing membrane failed to form. In Examples 2-18 through 2-21, no concentration of PEST could cause a free-standing membrane to form, confirming that the PVDF(534K) to LiTFSI ratio cannot fall below 35:65.

### Summary of Examples 3-1 Through 3-24 PVDF(700K)

In examples 3-1 through 3-24 described below, a series of polymer electrolyte compositions with varying amounts of PVDF(700K), LiTFSI, and PEST were formulated into a polymer electrolyte composite cathode and a polymer electrolyte separator, according to various embodiments of the present disclosure, and were tested.

### Examples 3-1 Through 3-7

In Examples 3-1 through 3-7, a polymer electrolyte was formulated according to the method of formulating a PiSE electrolyte with a PVDF(700K) according to the present disclosure. In the PiSE electrolyte, the a:b ratio where a is PVDF(700K) and b is LiTFSI was maintained at a 50:50 ratio. The portion of y to z where y is PVDF(700K) and LiTFSI and z is PEST was varied in the examples. In Example 3-1, y was 95 wt % and z was 5 wt %. In Example 3-2, y was decreased to 90 wt % and z was increased to 10 wt %. In Example 3-3, y was decreased to 85 wt % and z was increased to 15 wt %. In Example 3-4, y was decreased to 80 wt % and z was increased to 20 wt %. In Example 3-5, y was decreased to 75 wt % and z was increased to 25 wt %. In Example 3-6, y was decreased to 70 wt % and z was increased to 30 wt %. In Example 3-7, y was decreased to 65 wt % and z was increased to 35 wt %.

A composite cathode and a polymer electrolyte separator layer were prepared using the method for preparing of the present disclosure. In Examples 3-1 through 3-6, a cathode film was successfully formed and it was calendared to form a composite cathode. In Examples 3-1 through 3-6, a polymer electrolyte separator film was also successfully formed similar to the membrane in FIG. 4D. In Example 3-7, the cathode film and polymer electrolyte separator were not successfully formed. The formed membrane was wet similar to the membrane in FIG. 4E. The ionic conductivities of the membranes in Examples 3-1 through 3-6 at 25° C., 50° C., and 80° C. were measured and are reported in Table 3. All exceeded the threshold ionic conductivity of 1.0×10⁻⁵ S/cm.

### Examples 3-8 Through 3-14

In Examples 3-8 through 3-14, like in the preceding examples in the example 3 series, a polymer electrolyte was formulated according to the method of formulating a PiSE electrolyte with a PVDF(700K) according to the present disclosure. In these examples of the PiSE electrolyte, the a:b ratio where a is PVDF(700K) and b is LiTFSI was maintained at a 40:60 ratio. The portion of y to z where y is PVDF(700K) and LiTFSI and z is PEST was varied in the examples. In Example 3-8, like in Example 3-1, y was 95 wt % and z was 5 wt %. These concentrations were similarly varied until in Example 3-14 y was 65 wt % and z was 35 wt %.

A composite cathode and a polymer electrolyte separator layer were prepared using the method for preparing of the present disclosure. In Examples 3-8 through 3-13, a cathode film was successfully formed and it was calendared to form a composite cathode. In Examples 3-8 through 3-13, a polymer electrolyte separator film was also successfully formed similar to the membrane in FIG. 4D. In Example 3-14, the cathode film and polymer electrolyte separator were not successfully formed. The formed membrane was wet similar to the membrane in FIG. 4E. The ionic conductivities of the membranes in Examples 3-8 through 3-13 at 25° C., 50° C., and 80° C. were measured and are reported in Table 3. All exceeded the threshold ionic conductivity of 1.0×10⁻⁵ S/cm.

### Examples 3-15 Through 3-20

In Examples 3-15 through 3-20, like in the preceding examples in the example 3 series, a polymer electrolyte was formulated according to the method of formulating a PiSE electrolyte with a PVDF(700K) according to the present disclosure. In these examples of the PiSE electrolyte, the a:b ratio where a is PVDF(700K) and b is LiTFSI was maintained at a 35:65 ratio. The portion of y to z where y is PVDF(700K) and LiTFSI and z is PEST was varied in the examples. In Example 3-15, like in Example 3-1 and 3-8, y was 95 wt % and z was 5 wt %. These concentrations were similarly varied until in Example 3-20 y was 70 wt % and z was 30 wt %.

A composite cathode and a polymer electrolyte separator layer were prepared using the method for preparing of the present disclosure. In Examples 3-15 through 3-18, cathode films were successfully formed and it was calendared to form a composite cathode. In Examples 3-15 through 3-18, polymer electrolyte separator films were also successfully formed similar to the membrane in FIG. 4D. In Examples 3-19 and 3-20, the cathode films and polymer electrolyte separators were not successfully formed. The formed membranes were wet similar to the membrane in FIG. 4E. The ionic conductivities of the membranes in Examples 3-15 through 3-18 at 25° C., 50° C., and 80° C. were measured and are reported in Table 3. All exceeded the threshold ionic conductivity of 1.0×10⁻⁵ S/cm.

### Examples 3-21 Through 3-24

In Examples 3-21 through 3-24, like in the preceding examples in the example 3 series, a polymer electrolyte was formulated according to the method of formulating a PiSE electrolyte with a PVDF(700K) according to the present disclosure. In these examples of the PiSE electrolyte, the a:b ratio where a is PVDF(700K) and b is LiTFSI was maintained at a 30:70 ratio. The portion of y to z where y is PVDF(534K) and LiTFSI and z is PEST was varied in the examples. In Example 3-21, like in Example 3-1, 3-8, and 3-15, y was 95 wt % and z was 5 wt %. These concentrations were similarly varied until in Example 3-24 y was 80 wt % and z was 20 wt %.

A composite cathode and a polymer electrolyte separator layer were prepared using the method for preparing of the present disclosure. In all four examples 3-21 through 3-24, the cathode films and polymer electrolyte separators were not successfully formed. The formed membranes were wet similar to the membrane in FIG. 4E.

TABLE 3
Summary of Working Examples 3-1 through 3-24

| Working | | | z | Membrane | Ionic Conductivity (S/cm) | | |
|---|---|---|---|---|---|---|---|
| Examples | a:b | y | (PEST) | Quality | 25° C. | 50° C. | 80° C. |
| 3-1 | 50:50 | 95 | 5 | Good | 0.801 × 10⁻³ | 1.630 × 10⁻³ | 2.590 × 10⁻³ |
| 3-2 | | 90 | 10 | Good | 0.976 × 10⁻³ | 2.180 × 10⁻³ | 3.340 × 10⁻³ |
| 3-3 | | 85 | 15 | Good | 0.794 × 10⁻³ | 1.760 × 10⁻³ | 2.930 × 10⁻³ |
| 3-4 | | 80 | 20 | Good | 0.645 × 10⁻³ | 1.460 × 10⁻³ | 2.350 × 10⁻³ |
| 3-5 | | 75 | 25 | Good | 0.411 × 10⁻³ | 0.984 × 10⁻³ | 2.630 × 10⁻³ |
| 3-6 | | 70 | 30 | Good | 0.279 × 10⁻³ | 0.738 × 10⁻³ | 1.880 × 10⁻³ |
| 3-7 | | 65 | 35 | Fail (Wet) | N/A | N/A | N/A |
| 3-8 | 40:60 | 95 | 5 | Good | 0.739 × 10⁻³ | 1.310 × 10⁻³ | 2.010 × 10⁻³ |
| 3-8 | | 90 | 10 | Good | 0.768 × 10⁻³ | 1.390 × 10⁻³ | 2.520 × 10⁻³ |
| 3-10 | | 85 | 15 | Good | 0.578 × 10⁻³ | 1.340 × 10⁻³ | 2.410 × 10⁻³ |
| 3-11 | | 80 | 20 | Good | 0.434 × 10⁻³ | 1.160 × 10⁻³ | 2.170 × 10⁻³ |
| 3-12 | | 75 | 25 | Good | 0.571 × 10⁻³ | 1.350 × 10⁻³ | 2.770 × 10⁻³ |
| 3-13 | | 70 | 30 | Good | 0.502 × 10⁻³ | 1.150 × 10⁻³ | 2.160 × 10⁻³ |
| 3-14 | | 65 | 35 | Fail (Wet) | N/A | N/A | N/A |
| 3-15 | 35:65 | 95 | 5 | Good | 0.768 × 10⁻³ | 1.560 × 10⁻³ | 2.650 × 10⁻³ |
| 3-16 | | 90 | 10 | Good | 0.741 × 10⁻³ | 1.670 × 10⁻³ | 3.200 × 10⁻³ |
| 3-17 | | 85 | 15 | Good | 0.868 × 10⁻³ | 1.820 × 10⁻³ | 3.540 × 10⁻³ |
| 3-18 | | 80 | 20 | Good | 0.805 × 10⁻³ | 1.730 × 10⁻³ | 3.150 × 10⁻³ |
| 3-19 | | 75 | 25 | Fail (Wet) | N/A | N/A | N/A |
| 3-20 | | 70 | 30 | Fail (Wet) | N/A | N/A | N/A |
| 3-21 | 30:70 | 95 | 5 | Fail (Wet) | N/A | N/A | N/A |
| 3-22 | | 90 | 10 | Fail (Wet) | N/A | N/A | N/A |
| 3-23 | | 85 | 15 | Fail (Wet) | N/A | N/A | N/A |
| 3-24 | | 80 | 20 | Fail (Wet) | N/A | N/A | N/A |

Through Examples 3-1 through 3-24, the composition of PEST, PVDF(700K), and LiTFSI to form a free-standing membrane was determined. The same general testing procedure employed for the 2 series of examples to determine the boundary conditions for the PiSE using a PVDF(534K) was repeated.

In Examples 3-1 through 3-7, the PVDF(700K) to LiTFSI ratio was 50:50, it was varied to 40:60 in Examples 3-8 through 3-14, 35:65 in Examples 3-15 through 3-20, and 30:70 in Examples 3-21 through 3-24. As the PEST concentration was increased, the film will eventually fail to form a free-standing membrane as it is too wet. The amount of PEST where a free-standing membrane failed to form at each PVDF(700K) to LiTFSI ratio was determined. In Example 3-7, for a ratio of 50:50, at a 35 wt % PEST concentration, a free-standing membrane failed to form. In Example 3-14, for a ratio of 40:60, at a 35 wt % PEST concentration, a free-standing membrane failed to form. In Example 3-19, for a ratio of 35:65, at a 25 wt % PEST concentration, a free-standing membrane failed to form. In Examples 3-21 through 3-24, no concentration of PEST could cause a free-standing membrane to form, confirming that the PVDF(700K) to LiTFSI ratio cannot fall below 35:65.

### Summary of Examples 4-1 Through 4-22 PVDF(HSV900)

In examples 4-1 through 4-22 described below, a series of polymer electrolyte compositions with varying amounts of PVDF(HSV900), LiTFSI, and PEST were formulated into a polymer electrolyte composite cathode and a polymer electrolyte separator, according to various embodiments of the present disclosure, and were tested.

### Examples 4-1 Through 4-7

In Examples 4-1 through 4-7, a polymer electrolyte was formulated according to the method of formulating a PiSE electrolyte with a PVDF(HSV900) according to the present disclosure. In the PiSE electrolyte, the a:b ratio where a is PVDF(HSV900) and b is LiTFSI was maintained at a 50:50 ratio. The portion of y to z where y is PVDF(HSV900) and LiTFSI and z is PEST was varied in the examples. In Example 4-1, y was 95 wt % and z was 5 wt %. In Example 4-2, y was decreased to 90 wt % and z was increased to 10 wt %. In Example 4-3, y was decreased to 85 wt % and z was increased to 15 wt %. In Example 4-4, y was decreased to 80 wt % and z was increased to 20 wt %. In Example 4-5, y was decreased to 75 wt % and z was increased to 25 wt %. In Example 4-6, y was decreased to 70 wt % and z was increased to 30 wt %. In Example 4-7, y was decreased to 65 wt % and z was increased to 35 wt %.

A composite cathode and a polymer electrolyte separator layer were prepared using the method for preparing of the present disclosure. In Examples 4-1 through 4-6, a cathode film was successfully formed and calendared to form a composite cathode. In Examples 4-1 through 4-6, a polymer electrolyte separator film was also successfully formed similar to the membrane in FIG. 4D. In Example 4-7, the cathode film and polymer electrolyte separator were not successfully formed. The ionic conductivities of the membranes in Examples 4-1 through 4-6 at 25° C., 50° C., and 80° C. were measured and are reported in Table 4. All exceeded the threshold ionic conductivity of 1.0×10⁻⁵ S/cm.

### Example 4-8 Through 4-14

In Examples 4-8 through 4-14, like in the preceding examples in the example 4 series, a polymer electrolyte was formulated according to the method of formulating a PiSE electrolyte with a PVDF(HSV900) according to the present disclosure. In these examples of the PiSE electrolyte, the a:b ratio where a is PVDF(HSV900) and b is LiTFSI was maintained at a 40:60 ratio. The portion of y to z where y is PVDF(700K) and LiTFSI and z is PEST was varied in the examples. In Example 4-8, like in Example 4-1, y was 95 wt % and z was 5 wt %. These concentrations were similarly varied until in Example 4-14 y was 65 wt % and z was 35 wt %.

A composite cathode and a polymer electrolyte separator layer were prepared using the method for preparing of the present disclosure. In Examples 4-8 through 4-12, a cathode film was successfully formed and it was calendared to form a composite cathode. In Examples 4-8 through 4-12, a polymer electrolyte separator film was also successfully formed similar to the membrane in FIG. 4D. In Examples 4-13 and 4-14, the cathode films and polymer electrolyte separators were not successfully formed. The formed membranes were wet similar to the membrane in FIG. 4E. The ionic conductivities of the membranes in Examples 4-8 through 4-12 at 25° C., 50° C., and 80° C. were measured and are reported in Table 4 below. All exceeded the threshold ionic conductivity of 1.0×10⁻⁵ S/cm.

### Examples 4-15 Through 4-20

In Examples 4-15 through 4-20, like in the preceding examples in the example 4 series, a polymer electrolyte was formulated according to the method of formulating a PiSE electrolyte with a PVDF(HSV900) according to the present disclosure. In these examples of the PiSE electrolyte, the a:b ratio where a is PVDF(HSV900) and b is LiTFSI was maintained at a 35:65 ratio. The portion of y to z where y is PVDF(HSV900) and LiTFSI and z is PEST was varied in the examples. In Example 4-15, like in Example 4-1 and 4-8, y was 95 wt % and z was 5 wt %. These concentrations were similarly varied until in Example 4-20 y was 70 wt % and z was 30 wt %.

A composite cathode and a polymer electrolyte separator layer were prepared using the method for preparing of the present disclosure. In Examples 4-15 through 4-18, cathode films were successfully formed and it was calendared to form a composite cathode. In Examples 4-15 through 4-18, polymer electrolyte separator films were also successfully formed similar to the membrane in FIG. 4D. In Examples 4-19 and 4-20, the cathode films and polymer electrolyte separators were not successfully formed. The formed membranes were wet similar to the membrane in FIG. 4E. The ionic conductivities of the membranes in Examples 4-15 through 4-18 at 25° C., 50° C., and 80° C. were measured and are reported in Table 4. All exceeded the threshold ionic conductivity of 1.0×10⁻⁵ S/cm.

### Example 4-21 and 4-22

In Examples 4-21 and 4-22, like in the preceding examples in the example 4 series, a polymer electrolyte was formulated according to the method of formulating a PiSE electrolyte with a PVDF(HSV900) according to the present disclosure. In these examples of the PiSE electrolyte, the a:b ratio where a is PVDF(HSV900) and b is LiTFSI was maintained at a 30:70 ratio. In Example 4-21, y was 95 wt % and z was 5 wt %. In Example 4-22, y was 90 wt % and z was 10 wt %.

A composite cathode and a polymer electrolyte separator layer were prepared using the method for preparing of the present disclosure. In Examples 4-21 and 4-22, the cathode films and polymer electrolyte separators were not successfully formed. The formed membranes were wet similar to the membrane in FIG. 4E.

TABLE 4
Summary of Working Examples 4-1 through 4-22

| Working | | | z | Membrane | Ionic Conductivity (S/cm) | | |
|---|---|---|---|---|---|---|---|
| Examples | a:b | y | (PEST) | Quality | 25° C. | 50° C. | 80° C. |
| 4-1 | 50:50 | 95 | 5 | Good | 0.454 × 10⁻³ | 0.971 × 10⁻³ | 1.530 × 10⁻³ |
| 4-2 | | 90 | 10 | Good | 0.404 × 10⁻³ | 0.989 × 10⁻³ | 1.230 × 10⁻³ |
| 4-3 | | 85 | 15 | Good | 0.267 × 10⁻³ | 0.691 × 10⁻³ | 1.480 × 10⁻³ |
| 4-4 | | 80 | 20 | Good | 0.272 × 10⁻³ | 0.629 × 10⁻³ | 1.030 × 10⁻³ |
| 4-5 | | 75 | 25 | Good | 0.501 × 10⁻³ | 0.805 × 10⁻³ | 1.120 × 10⁻³ |
| 4-6 | | 70 | 30 | Good | 0.467 × 10⁻³ | 0.905 × 10⁻³ | 1.630 × 10⁻³ |
| 4-7 | | 65 | 35 | Fail (Wet) | N/A | N/A | N/A |
| 4-8 | 40:60 | 95 | 5 | Good | 0.584 × 10⁻³ | 1.210 × 10⁻³ | 2.640 × 10⁻³ |
| 4-9 | | 90 | 10 | Good | 0.609 × 10⁻³ | 1.090 × 10⁻³ | 2.000 × 10⁻³ |
| 4-10 | | 85 | 15 | Good | 0.509 × 10⁻³ | 1.110 × 10⁻³ | 2.400 × 10⁻³ |
| 4-11 | | 80 | 20 | Good | 0.457 × 10⁻³ | 1.020 × 10⁻³ | 1.850 × 10⁻³ |
| 4-12 | | 75 | 25 | Good | 0.365 × 10⁻³ | 0.970 × 10⁻³ | 1.990 × 10⁻³ |
| 4-13 | | 70 | 30 | Fail (Wet) | N/A | N/A | N/A |
| 4-14 | | 65 | 35 | Fail (Wet) | N/A | N/A | N/A |
| 4-15 | 35:65 | 95 | 5 | Good | 0.625 × 10⁻³ | 1.150 × 10⁻³ | 2.240 × 10⁻³ |
| 4-16 | | 90 | 10 | Good | 0.624 × 10⁻³ | 0.960 × 10⁻³ | 2.140 × 10⁻³ |
| 4-17 | | 85 | 15 | Good | 0.648 × 10⁻³ | 1.380 × 10⁻³ | 2.280 × 10⁻³ |
| 4-18 | | 80 | 20 | Good | 0.711 × 10⁻³ | 1.380 × 10⁻³ | 2.260 × 10⁻³ |
| 4-19 | | 75 | 25 | Fail (Wet) | N/A | N/A | N/A |
| 4-20 | | 70 | 30 | Fail (Wet) | N/A | N/A | N/A |
| 4-21 | 30:70 | 95 | 5 | Fail (Wet) | N/A | N/A | N/A |
| 4-22 | | 90 | 10 | Fail (Wet) | N/A | N/A | N/A |

Through Examples 4-1 through 4-22, the composition of PEST, PVDF(HSV900), and LiTFSI to form a free-standing membrane was determined. The same general testing procedure employed for the 2 and 3 series of examples to determine the boundary conditions for the PiSE using a PVDF(534K) and PVDF(700K) was also repeated for PVDF(HSV900).

In Examples 4-1 through 4-7, the PVDF(HSV900) to LiTFSI ratio was 50:50, it was varied to 40:60 in Examples 4-8 through 4-14, 35:65 in Examples 4-15 through 4-20, and 30:70 in Examples 4-21 through 4-22. As the PEST concentration was increased, the film's quality eventually failed to form a free-standing membrane as it became too wet. The amount of PEST where a free-standing membrane failed to form at each PVDF(HSV900) to LiTFSI ratio was determined. In Example 4-7, for a ratio of 50:50, at a 35 wt % PEST concentration, a free-standing membrane failed to form. In Example 4-13, for a ratio of 40:60, at a 30 wt % PEST concentration, a free-standing membrane failed to form. In Example 4-19, for a ratio of 35:65, at a 25 wt % PEST concentration, a free-standing membrane failed to form. In Examples 4-21 through 4-22, no concentration of PEST could cause a free-standing membrane to form, confirming that the PVDF(HSV900) to LiTFSI ratio cannot fall below 35:65.

### Example 5-1 (LFP with SiPE Variant #1)

In Example 5-1 a SiPE mixture was prepared using the method for preparation of a SiPE polymer electrolyte mixture of the present disclosure. PEST was used as the polymer, LiTFSI and LiBF₄ were used as the dual lithium salt. The concentration of PEST was 80 wt %, the concentration of LiTFSI 18 wt %, and the concentration of LiBF₄ 2 wt %.

A slurry and a composite cathode were also prepared following the method of preparation of a slurry mixture of the polymer electrolyte composite cathode of the present disclosure. The cathode active material used for the composite cathode was lithium iron phosphate (LFP). A polymer electrolyte mixture was also prepared using the method for preparing a polymer electrolyte mixture of the present disclosure. The polymer electrolyte separator was then dissolved in acetonitrile (AN) and solution cast on the LFP based composite cathode formed earlier. The AN was evaporated by placing the film into a small antechamber in the glovebox and inducing a slight vacuum. The process was repeated twice to ensure a dense and uniform film deposit on the LFP based composite cathode. After that, a thick Li-metal (500 μm) was placed on top and together with the LFP composite cathode with formed polymer electrolyte layer was assembled into a coin cell. The LFP composite cathode, polymer electrolyte layer, and lithium metal stack were 16 mm in diameter.

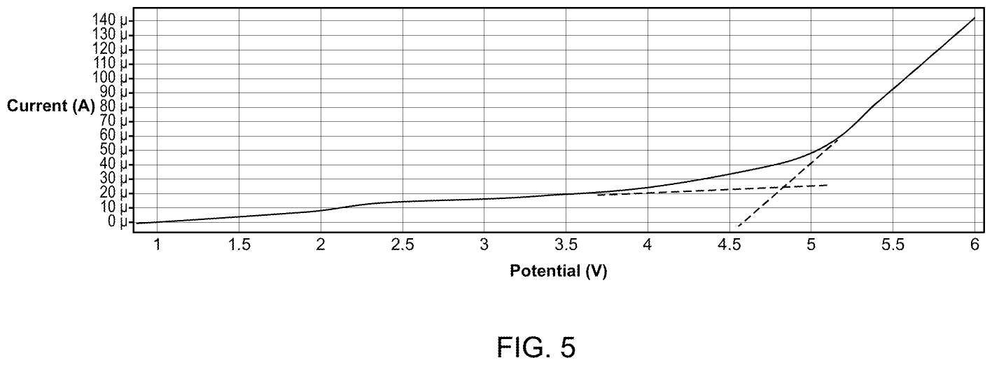

FIG. 5 shows a linear sweep voltammetry (LSV) of the polymer electrolyte as measured and its ESW. The flat areas between both major peaks (far left and far right) indicates a voltage window of 4.8V as calculated at the point where the tangents cross.

### Example 5-2 (LFP with SiPE Variant #1 and Dry Placement)

In Example 5-1, the steps for preparing a slurry mixture and a composite cathode were repeated. Like Example 5-1, PEST was used as the polymer, LiTFSI and LiBF₄ were used as the dual lithium salt. Like Example 5-1, the cathode active material used for the composite cathode was lithium iron phosphate (LFP). Like Example 5-1, a polymer electrolyte mixture was also prepared using the method for preparing a polymer electrolyte mixture of the present disclosure. The concentration of PEST was 80 wt %, the concentration of LiTFSI 19.5 wt %, and the concentration of LiBF₄ 0.5 wt %. And different from Example 5-1, the polymer electrolyte was then cast into a Teflon evaporation dish and the solvent was evaporated. Once evaporated, a polymer electrolyte free-standing membrane was formed, peeled from the dish, and shaped into circular disks having 16 mm in diameter for a coin cell. The circular disk was then dry placed onto the composite cathode. A thick Li-metal (500 μm) was then placed on top of the circular disk. The composite cathode, polymer electrolyte separator layer, and lithium metal anode layer were finally assembled into a coin cell. Another identical coin cell was similarly made.

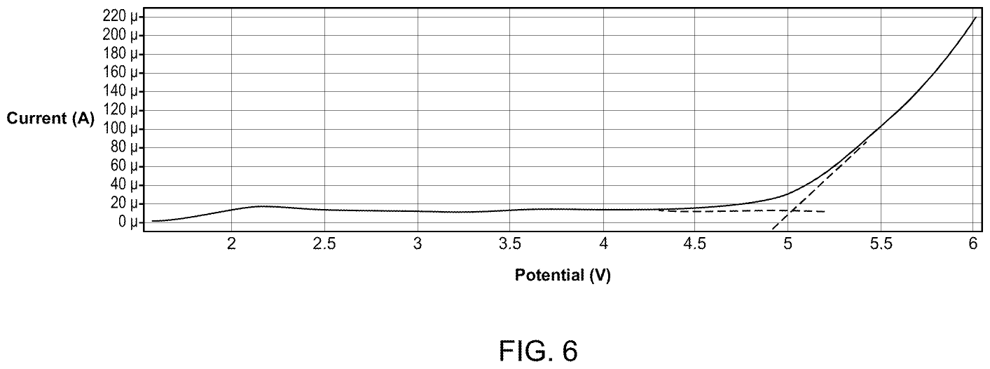

FIG. 6 shows a linear sweep voltammetry (LSV) of the polymer electrolyte as measured and its ESW. The flat areas between both major peaks (far left and far right) indicated a voltage window of 5.0V as calculated at the point where the tangents cross.

### Prophetic Example 5-3 (LFP with PiSE Variant #2)

In Example 5-3 a PiSE mixture is prepared using the method for preparation of a PiSE polymer electrolyte mixture of the present disclosure. PEST is used as the polymer, PVDF(534K) as the PVDF, and LiTFSI as the lithium salt. The ratio of PVDF(534K) to LiTFSI is 35:65. The concentration of PVDF(534K) and LiTFSI are 90 wt % of the total concentration, the concentration of PEST is 10 wt %.

A slurry and a composite cathode are then prepared following the method of preparation of a slurry mixture of the polymer electrolyte composite cathode of the present disclosure. Lithium iron phosphate (LFP) is used as the cathode active material for the composite cathode. A polymer electrolyte mixture is also prepared using the method for preparing a polymer electrolyte mixture of the present disclosure. The polymer electrolyte mixture is then dissolved in acetonitrile (AN) and solution cast on the first formed LFP based composite cathode. The AN is evaporated by placing the film into a small antechamber in the glovebox and inducing a slight vacuum. The process is repeated twice to ensure a dense and uniform film deposit on the LFP based composite cathode. After that, a thick Li-metal (500 μm) is placed on top and together with the LFP composite cathode with a formed polymer electrolyte layer, assembled into a coin cell. The LFP composite cathode, polymer electrolyte layer, and lithium metal stack are 16 mm in diameter.

### Prophetic Example 5-4 (LFP with SiPE Variant #1 in a Pouch Cell)

In Example 5-4, a polymer electrolyte mixture is prepared using the method for preparation of a SiPE polymer electrolyte mixture of the present disclosure. PEST is used as the polymer, LiTFSI and LiBF₄ are used as the dual lithium salts. The concentration of PEST is 80 wt %, the concentration of LiTFSI is 18 wt %, and the concentration of is LiBF₄ 2 wt %.

The steps for preparing a slurry mixture and a composite cathode of the present disclosure are carried out. The cathode active material used for the composite cathode is lithium iron phosphate (LFP). Like Example 5-1, a polymer electrolyte mixture is also prepared using the method for preparing a polymer electrolyte mixture of the present disclosure. But different from Examples 5-1 and 5-2, the composite cathode, polymer electrolyte separator layer, and lithium metal anode layer are shaped in a format suitable for a pouch cell. The polymer electrolyte mixture is cast into a Teflon evaporation dish and the solvent is evaporated to form a polymer electrolyte layer. The Teflon evaporation dish is of a size suitable to form a quadrilateral and in this example a 50 mm×50 mm square polymer electrolyte layer is formed. A composite cathode and a lithium metal anode each 50 mm×50 mm are similarly formed.

The composite cathode, polymer electrolyte layer, and lithium metal anode are assembled into a pouch cell using the method for assembly a pouch cell of the present disclosure. A lead tab, which can be made of nickel, is welded to the composite cathode and polymer electrolyte layer piece. The lithium metal anode piece is cut dimensionally to be the same as the composite cathode and the polymer electrolyte layer is layered together to form a unit cell. The unit cell is inserted between two plastic inserts to provide mechanical rigidity. Additionally, an insulating material, which can be made of polyolefin, is wrapped around the entire unit cell and plastic insert assembly. This assembly is then inserted into a heat sealing foil and sealed to form a lithium-ion battery pouch cell.

### Prophetic Example 6 (NMC811 with SiPE Variant #1)

In Example 6 a SiPE polymer electrolyte mixture is also prepared using the method for preparation of a SiPE polymer electrolyte mixture of the present disclosure. PEST is used as the polymer, LiTFSI and LiBF₄ are used as the dual lithium salt. The concentration of PEST is 80 wt %, the concentration of LiTFSI 18 wt %, and the concentration of LiBF₄ 2 wt %.

A slurry and a composite cathode are then prepared following the method of preparation of a slurry mixture of the polymer electrolyte composite cathode of the present disclosure. The cathode active material used for the composite cathode is lithium nickel manganese cobalt oxide (NMC) with a nickel, manganese, and cobalt content of 80%, 10%, and 10%, respectively, and is commonly known as NMC811. A SiPE polymer electrolyte mixture is also prepared using the method for preparing a SiPE polymer electrolyte mixture of the present disclosure. The SiPE polymer electrolyte mixture is dissolved in acetonitrile (AN) and solution cast on the first formed NMC811 based composite cathode. The AN is evaporated by placing the film into a small antechamber in the glovebox and inducing a slight vacuum. The process is repeated twice to ensure a dense and uniform film deposit on the NMC811 composite cathode. After that, a thick Li-metal (500 μm) is placed on top and, together with the NMC811 composite cathode with the formed polymer electrolyte layer, is assembled into a coin cell. The NMC811 composite cathode, polymer electrolyte layer, and lithium metal stack are 16 mm in diameter.

The polymer electrolyte of the present disclosure is comprised of a polysiloxane si-tripodand polymer, lithium salts such as lithium bis(trifluoromethanesulfonyl)imide and/or a lithium tetrafluoroborate, and a polyvinylidene difluoride. The polymer electrolyte of the present disclosure can be formed into a free-standing membrane. The polymer electrolyte of the present disclosure is also formulated as two variants. In Variant #1, a salt in polymer electrolyte (SiPE), the polymer electrolyte is formulated using different quantities of a polysiloxane Si-tripodand polymer, a lithium bis(trifluoromethanesulfonyl)imide, and a lithium tetrafluoroborate in various embodiments of the present disclosure to deliver the required ionic conductivity while forming a free-standing membrane. In Variant #2, a polymer in salt electrolyte (PiSE), the polymer electrolyte is formulated using different quantities of a polysiloxane Si-tripodand polymer, polyvinylidene difluoride, and a lithium bis(trifluoromethanesulfonyl)imide in various embodiments of the present disclosure to deliver the required ionic conductivity while forming a free-standing membrane. The polyvinylidene difluoride can be a PVDF(534K), a PVDF(700K), or a PVDF(HSV900).

The polymer electrolyte is technically and commercially viable as a catholyte in a composite cathode and as a polymer electrolyte separator, and can together or separately function as components of a solid state or semi-solid rechargeable battery. The polymer electrolyte, as tested, exhibits an ionic conductivity of 1.0×10⁻⁵ S/cm or greater at 25° C. or greater in its various embodiments.

Furthermore, because the polymer electrolyte can easily be manufactured into a free-standing membrane, its technical and commercial viability as a catholyte in a composite cathode or as a separator between a cathode and an anode is further enhanced. The composite cathode, using the polymer electrolyte as a catholyte, can be manufactured with relative ease through solution casting the composite cathode directly onto a current collector or other substrate. As a polymer electrolyte separator, the polymer electrolyte can also be solution cast onto the composite cathode or other substrate. Alternatively, the polymer electrolyte separator can be formed without solution casting directly onto the composite cathode. It can be cast onto an entirely different substrate, peeled off, and then dry placed onto the composite cathode. These manufacturing processes, which do not require high pressure, are beneficial over conventional manufacturing processes for solid electrolytes in solid state batteries, which require significant levels of pressure to form the electrolyte. Conventional methods also require integration of the polymer electrolyte into the solid electrolyte material.

The composite cathode and polymer electrolyte separator can function together or separately as components of a rechargeable lithium-ion coin cell or pouch cell. The composite cathode and separator can also function with different cathode active materials such as LFP and NMC811. The composite cathode and polymer electrolyte separator can also be applied to a rechargeable lithium-ion cell with a lithium metal anode.

What is claimed is:

1. A polymer electrolyte, comprising:
a polysiloxane Si-tripodand polymer;
a lithium bis(trifluoromethanesulfonyl)imide; and
a lithium tetrafluoroborate,
the polysiloxane Si-tripodand polymer, the lithium bis(trifluoromethanesulfonyl)imide, and the lithium tetrafluoroborate formed into a free-standing membrane.

2. The polymer electrolyte of claim 1, wherein the polymer electrolyte comprises 70 wt % to 90 wt % of the polysiloxane si-tripodand polymer.

3. The polymer electrolyte of claim 1, wherein the polymer electrolyte comprises 8.0 wt % to 29.75 wt % of the lithium bis(trifluoromethanesulfonyl)imide.

4. The polymer electrolyte of claim 1, wherein the polymer electrolyte comprises 0.25 wt % to 3.0 wt % of the lithium tetrafluoroborate.

5. The polymer electrolyte of claim 1, wherein the polymer electrolyte has an ionic conductivity greater than 1×10⁻⁵ S/cm at a temperature greater than or equal to 25° C.

6. A polymer electrolyte, comprising:
a polysiloxane Si-tripodand polymer;
a polyvinylidene difluoride;
a lithium bis(trifluoromethanesulfonyl)imide; and
the polysiloxane Si-tripodand polymer, the lithium polyvinylidene difluoride, and the lithium bis(trifluoromethanesulfonyl)imide formed into a free-standing membrane.

7. The polymer electrolyte of claim 6, wherein the polyvinylidene difluoride is a PVDF(534K).

8. The polymer electrolyte of claim 7, wherein the polymer electrolyte comprises 5 wt % to 30 wt % of the polysiloxane Si-tripodand polymer when a ratio of the polyvinylidene difluoride to the lithium bis(trifluoromethanesulfonyl)imide is 50:50.

9. The polymer electrolyte of claim 7, wherein the polymer electrolyte comprises 5 wt % to 20 wt % of the polysiloxane Si-tripodand polymer when a ratio of the polyvinylidene difluoride to the lithium bis(trifluoromethanesulfonyl)imide is 40:60.

10. The polymer electrolyte of claim 7, wherein the polymer electrolyte comprises 5 wt % to 10 wt % of the polysiloxane Si-tripodand polymer when a ratio of the polyvinylidene difluoride to the lithium bis(trifluoromethanesulfonyl)imide is 35:65.

11. The polymer electrolyte of claim 6, wherein the polyvinylidene difluoride is a PVDF(700K).

12. The polymer electrolyte of claim 11, wherein the polymer electrolyte comprises 5 wt % to 30 wt % of the polysiloxane Si-tripodand polymer when a ratio of the polyvinylidene difluoride to the lithium bis(trifluoromethanesulfonyl)imide is 50:50.

13. The polymer electrolyte of claim 11, wherein the polymer electrolyte comprises 5 wt % to 30 wt % of the polysiloxane Si-tripodand polymer when a ratio of the polyvinylidene difluoride to the lithium bis(trifluoromethanesulfonyl)imide is 40:60.

14. The polymer electrolyte of claim 11, wherein the polymer electrolyte comprises 5 wt % to 20 wt % of the polysiloxane Si-tripodand polymer when a ratio of the polyvinylidene difluoride to the lithium bis(trifluoromethanesulfonyl)imide is 35:65.

15. The polymer electrolyte of claim 6, wherein the polyvinylidene difluoride is a PVDF(HSV900).

16. The polymer electrolyte of claim 15, wherein the polymer electrolyte comprises 5 wt % to 30 wt % of the polysiloxane Si-tripodand polymer when a ratio of polyvinylidene difluoride to lithium bis(trifluoromethanesulfonyl)imide is 50:50.

17. The polymer electrolyte of claim 15, wherein the polymer electrolyte comprises 5 wt % to 25 wt % of the polysiloxane Si-tripodand polymer when a ratio of polyvinylidene difluoride to lithium bis(trifluoromethanesulfonyl)imide is 40:60.

18. The polymer electrolyte of claim 15, wherein the polymer electrolyte comprises 5 wt % to 20 wt % of the polysiloxane Si-tripodand polymer when a ratio of polyvinylidene difluoride to lithium bis(trifluoromethanesulfonyl)imide is 35:65.

19. The polymer electrolyte of claim 6, wherein the polymer electrolyte has an ionic conductivity greater than 1×10⁻⁵ S/cm at a temperature greater than or equal to 25° C.

20. A method of manufacturing the polymer electrolyte of claim 1, comprising:
dissolving a polysiloxane Si-tripodand polymer in a first organic solvent;
dissolving a lithium bis(trifluoromethanesulfonyl)imide in a second organic solvent;
dissolving a lithium tetrafluoroborate in the second organic solvent;
adding the second organic solvent containing the lithium bis(trifluoromethanesulfonyl)imide and the lithium tetrafluoroborate to the first organic solvent containing the polysiloxane Si-tripodand polymer to form a mixture; and
heating the mixture under heat to obtain a homogeneous mixture.

21. A method of manufacturing the polymer electrolyte of claim 6, comprising:
dissolving a polysiloxane Si-tripodand polymer in a first organic solvent;
dissolving a lithium bis(trifluoromethanesulfonyl)imide in a second organic solvent;
adding a polyvinylidene difluoride to the second organic solvent containing the lithium bis(trifluoromethanesulfonyl)imide;
adding the second organic solvent containing the polyvinylidene difluoride and the lithium bis(trifluoromethanesulfonyl)imide to the first organic solvent containing the polysiloxane Si-tripodand polymer; and
heating the mixture under heat to obtain a homogeneous mixture.

22. A composite cathode for a rechargeable battery cell, comprising:
a cathode active material;
a carbon-containing material;
the polymer electrolyte of claim 1; and
a polyvinylidene difluoride binder binding the cathode active material, the carbon-containing material, and the polymer electrolyte,
wherein the cathode active material, the carbon-containing material, the polyvinylidene difluoride binder, and the polymer electrolyte are formed as a cathode film; and
wherein the cathode film is formed on a current collector.

23. The composite cathode of claim 22, wherein the polymer electrolyte functions as a catholyte.

24. The composite cathode of claim 22, wherein the cathode active material is a lithium iron phosphate.

25. The composite cathode of claim 22, wherein the cathode active material is a lithium nickel manganese cobalt oxide (NMC) and more than 50% of the nickel manganese cobalt oxide is nickel.

26. A composite cathode for a rechargeable battery cell, comprising:
a cathode active material;
a carbon-containing material;
the polymer electrolyte of claim 6; and
a polyvinylidene difluoride binder binding the cathode active material, the carbon-containing material, and the polymer electrolyte,
wherein the cathode active material, the carbon-containing material, the polyvinylidene difluoride binder, and the polymer electrolyte are formed as a cathode film; and
wherein the cathode film is formed on a current collector.

27. The composite cathode of claim 26, wherein the cathode active material is a lithium iron phosphate.

28. The composite cathode of claim 26, wherein the cathode active material is a lithium nickel manganese cobalt oxide (NMC) and more than 50% of the nickel manganese cobalt oxide is nickel.

29. A polymer electrolyte separator for a rechargeable battery cell, the polymer electrolyte separator comprising the polymer electrolyte of claim 1, wherein the polymer electrolyte is formed as a solid layer, the solid layer immediately adjacent a cathode layer and an anode layer of the rechargeable battery cell.

30. The polymer electrolyte separator of claim 29, wherein the solid layer is formed by dry placing the solid layer between the cathode layer and the anode layer.

31. A polymer electrolyte separator for a rechargeable battery cell, the polymer electrolyte separator comprising the polymer electrolyte of claim 6, wherein the polymer electrolyte is formed as a solid layer, the solid layer immediately adjacent a cathode layer and an anode layer of the rechargeable battery cell.

32. The polymer electrolyte separator of claim 31, wherein the solid layer is formed by dry placing the solid layer between the cathode layer and the anode layer.

33. A method for manufacturing a composite cathode for a rechargeable battery cell, comprising:
preparing the polymer electrolyte according to the method of claim 20;
mixing the polymer electrolyte with a cathode active material, a carbon-containing material, and a polyvinylidene difluoride binder to form a slurry mixture;
casting the slurry mixture on a current collector;
spreading the slurry mixture on the current collector;
removing the solvent in the slurry mixture to form a cathode film layer; and
calendaring the cathode film layer and the current collector.

34. The method of claim 33, wherein the cathode film layer and the current collector are calendared to increase the density of the cathode film layer to 1.7 g/cm³.

35. A method for manufacturing a composite cathode for a rechargeable battery cell, comprising:
preparing the polymer electrolyte according to the method of claim 21;
mixing the polymer electrolyte with a cathode active material, a carbon-containing material, and a polyvinylidene difluoride binder to form a slurry mixture;
casting the slurry mixture on a current collector;
spreading the slurry mixture on the current collector;
removing the solvent in the slurry mixture to form a cathode film layer; and
calendaring the cathode film layer and the current collector.

36. The method of claim 35, wherein the cathode film layer and the current collector are calendared to increase the density of the cathode film layer to 1.7 g/cm³.

37. A method of manufacturing an electrode stack, comprising:
preparing a first portion and a second portion of the polymer electrolyte according to the method of claim 20;
forming a composite cathode by
mixing the first portion of the polymer electrolyte with a cathode active material, a carbon-containing material, and a polyvinylidene difluoride binder to form a slurry mixture;
casting the slurry mixture on a current collector;
spreading the slurry mixture on the current collector;
removing the solvent in the slurry mixture to form a cathode film layer; and
calendaring the cathode film layer and the current collector;
forming the second portion of the polymer electrolyte on the composite cathode as a separator layer;
forming an anode layer on a negative current collector; and
stacking the anode layer and the negative current collector on the separator layer, and
wherein the separator layer is dry placed on the composite cathode.

38. A method of manufacturing an electrode stack, comprising:
preparing a first portion and a second portion of the polymer electrolyte according to the method of claim 21;
forming a composite cathode by
mixing the first portion of the polymer electrolyte with a cathode active material, a carbon-containing material, and a polyvinylidene difluoride binder to form a slurry mixture;
casting the slurry mixture on a current collector;
spreading the slurry mixture on the current collector;
removing the solvent in the slurry mixture to form a cathode film layer; and
calendaring the cathode film layer and the current collector;
forming the second portion of the polymer electrolyte on the composite cathode as a separator layer;
forming an anode layer on a negative current collector; and
stacking the anode layer and the negative current collector on the separator layer, and
wherein the separator layer is dry placed on the composite cathode.

39. A rechargeable battery cell comprising:
the composite cathode of claim 22 formed as a cathode layer on a first current collector to form a positive electrode;
an anode layer formed on a second current collector to form a negative electrode, wherein the anode layer is a lithium metal; and
a polymer electrolyte separator comprising:
a polymer electrolyte, comprising:
a polysiloxane Si-tripodand polymer;
a lithium bis(trifluoromethanesulfonyl)imide; and
a lithium tetrafluoroborate,
the polysiloxane Si-tripodand polymer, the lithium bis(trifluoromethanesulfonyl)imide, and the lithium tetrafluoroborate formed into a free-standing membrane,
wherein the polymer electrolyte separator is immediately adjacent the cathode layer and the anode layer,
wherein the cathode layer, the anode layer, and the polymer electrolyte separator are solid.

40. The rechargeable battery cell of claim 39, wherein the rechargeable battery cell does not contain any liquid electrolyte.

41. The rechargeable battery cell of claim 39, wherein the cathode active material in the composite cathode is a lithium iron phosphate.

42. The rechargeable battery cell of claim 39, wherein the cathode active material in the composite cathode is a lithium nickel manganese cobalt oxide with a nickel content greater than 50% of the cathode active material.

43. A rechargeable battery cell comprising:
the composite cathode of claim 26 formed as a cathode layer on a first current collector to form a positive electrode;
an anode layer formed on a second current collector to form a negative electrode, wherein the anode layer is a lithium metal; and
a polymer electrolyte separator comprising:
a polymer electrolyte comprising:
a polysiloxane Si-tripodand polymer;
a polyvinylidene difluoride;
a lithium bis(trifluoromethanesulfonyl)imide; and
the polysiloxane Si-tripodand polymer, the lithium polyvinylidene difluoride, and the lithium bis(trifluoromethanesulfonyl)imide formed into a free-standing membrane,
wherein the polymer electrolyte separator is immediately adjacent the cathode layer and the anode layer;
wherein the cathode layer, the anode layer, and the polymer electrolyte separator are solid.

44. The rechargeable battery cell of claim 43, wherein the rechargeable battery cell does not contain any liquid electrolyte.

45. The rechargeable battery cell of claim 43, wherein the cathode active material in the composite cathode is a lithium iron phosphate.

46. The rechargeable battery cell of claim 43, wherein the cathode active material in the composite cathode is a lithium nickel manganese cobalt oxide with a nickel content greater than 50% of the cathode active material.
